(19) United States
(12) Patent Application Publication
(10) Pub. No.: US 2017/0163209 A1
(43) Pub. Date: Jun. 8, 2017

(54) SYSTEMS, VEHICLES, AND METHODS FOR MAINTAINING RAIL-BASED ARRAYS OF PHOTOVOLTAIC MODULES

(71) Applicant: Alion Energy, Inc., Richmond, CA (US)

(72) Inventors: Sean Bailey, Emeryville, CA (US); Mark Kingsley, Hollis, NH (US); Rodney Hans Holland, Novato, CA (US); Jesse Atkinson, San Francisco, CA (US); Karl Johnson, Berkeley, CA (US); Thomas Goehring, Berkeley, CA (US); Adam French, San Francisco, CA (US)

(21) Appl. No.: 15/356,242

(22) Filed: Nov. 18, 2016

Related U.S. Application Data
(60) Provisional application No. 62/260,015, filed on Nov. 25, 2015.
(60) Provisional application No. 62/269,893, filed on Dec. 18, 2015.

(51) Int. Cl. H02S 30/00; H02S 40/34; H02S 99/00

(52) U.S. Cl. CPC H02S 30/00; H02S 99/00; H02S 40/34

(57) ABSTRACT

A system for maintaining photovoltaic modules includes an elongated rail including first and second support surfaces and a first mounting surface disposed between the first and second support surfaces. An array of the photovoltaic modules is coupled to the first mounting surface and raised relative to the first and second support surfaces. A first vehicle can be disposed on the first and second support surfaces and can include a motor; a maintenance module selected from the group consisting of: a spray system configured to spray a product, and a remote inspection module; and first and second support legs suspending the maintenance module relative to the photovoltaic modules of the first array and being movably coupled to the first and second support surfaces so as to laterally and sequentially move the maintenance module in a direction parallel to the elongated rail responsive to actuation of the motor.

### CROSS-REFERENCE TO RELATED APPLICATIONS

This application claims priority to the following applications, the entire contents of each of which are incorporated by reference herein for all purposes:

U.S. Provisional Application No. 62/260,015, filed Nov. 25, 2015 and entitled “SPOT Protective Coatings Application and Other Advanced Operation and Maintenance;” and

U.S. Provisional Application No. 62/269,893, filed Dec. 18, 2015 and entitled “SPOT maintenance vehicle coatings application between tracks.”

### BACKGROUND

The present invention is directed to photovoltaic modules according to certain embodiments. More particularly, some embodiments of the invention provide systems, vehicles, and methods for maintaining rail-based arrays of photovoltaic modules. However, it would be recognized that the invention has a much broader range of applicability.

Photovoltaics convert sunlight into electricity, providing a desirable source of clean energy. FIG. 1 is a simplified diagram of a conventional photovoltaic array. The photovoltaic array 100 includes strings 1, 2, 3, 4, . . . n, where n is a positive integer larger than or equal to 1. Each string includes photovoltaic (PV) modules (e.g., solar panels) that are connected in series. The photovoltaic array 100 is connected to a central inverter 110, which provides an alternating current (AC) connection to a power grid 120. FIG. 2 is a simplified diagram of a conventional photovoltaic module. The photovoltaic (PV) module 210 includes a junction box 220 on the backside of the PV module 210.

The installation of photovoltaic arrays often presents logistical challenges. Not only does the site for the photovoltaic array need to be properly prepared, but large quantities of materials also need to be transported to and within the site. For example, the site for the photovoltaic array may have existing vegetation that would interfere with the installation and operation of the photovoltaic array. This vegetation usually has to be cleared. The site may also have uneven terrain that usually requires extensive grading and earth moving. Once the site is prepared, it is then often necessary to build an extensive infrastructure on which the strings of PV modules 210 are to be affixed. The PV modules 210 are then moved into position, affixed to the structure, and interconnected so that power can be delivered to the power grid 120. Each of these operations can be time-consuming and expensive.

Once the photovoltaic array is in operation, additional infrastructure often is used to support, maintain, evaluate, and repair the array. In order to support the operation of the photovoltaic array, equipment and materials routinely need to be transported from one end of the array to another. For example, the test equipment is transported to a PV module that is under evaluation. In another example, the cleaning equipment is transported to remove debris and dirt from the PV module. In yet another example, an additional module is transported as replacement for the defective module. Depending upon the terrain, soils, and weather, simply getting equipment and materials from one end of the array to another often poses significant challenges, especially if the ground is muddy. As with the installation, these operational needs can also be time-consuming and expensive.

Hence, it is highly desirable to improve techniques for installation and operation of photovoltaic arrays.

### SUMMARY OF INVENTION

The present invention is directed to photovoltaic modules according to certain embodiments. More particularly, some embodiments of the invention provide systems, vehicles, and methods for operating and maintaining rail-based arrays of photovoltaic modules. However, it would be recognized that the invention has a much broader range of applicability.

According one embodiment, a system for maintaining photovoltaic modules includes a first elongated rail including first and second support surfaces and a first mounting surface disposed between the first and second support surfaces, a first array of the photovoltaic modules being coupled to the first mounting surface and raised relative to the first and second support surfaces. The system also can include a first vehicle disposed on the first and second support surfaces. The first vehicle can include a motor; a maintenance module selected from the group consisting of: a spray system configured to spray a product, and a remote inspection module; and first and second support legs suspending the maintenance module relative to the photovoltaic modules of the first array and being movably coupled to the first and second support surfaces so as to laterally and sequentially move the maintenance module in a direction parallel to the first elongated rail responsive to actuation of the motor.

In some embodiments, the spray system optionally can include a reservoir storing the product and a spray nozzle coupled to the reservoir and configured to spray the product. The product optionally can include one or more of a protective material, an herbicide, a reflective coating, a dust suppressor, an insecticide, an animal deterrent, or a seed. The product optionally can include a liquid or optionally can include a powder.

In some embodiments, the first elongated rail optionally is disposed on an installation surface, and the spray nozzle optionally is configured so as to spray the product on the installation surface. The system optionally further can include a second elongated rail supporting a second array of photovoltaic modules. The spray nozzle optionally can be configured so as to spray the product on a region of the installation surface between the first elongated rail and the second elongated rail. The product optionally can include a reflective coating or optionally can include an herbicide.

The spray nozzle optionally can be configured so as to spray the product on one or more backsheets of the photovoltaic modules of the first array. The product optionally can include a protective material configured so as to improve weatherability of the photovoltaic modules of the first array.

The spray nozzle optionally can be configured so as to spray the product on the first elongated rail. The product optionally can include a protective material configured so as to improve weatherability or sealant to repair one or more cracks in the first elongated rail.

In some embodiments, the system optionally further includes array wiring or a module junction box coupling the photovoltaic modules of the first array to one another. The spray nozzle optionally can be configured so as to spray the product on the array wiring or the module junction box. The product optionally can include an insulating layer.

In some embodiments, the system optionally further includes a plurality of legs coupling the photovoltaic modules of the first array to the first mounting surface. The spray nozzle optionally can be configured so as to spray the product on the legs. The product optionally can include an oxidation inhibitor.

The spray nozzle optionally can be configured so as to spray the product on photovoltaic surfaces of the first array of photovoltaic modules. The product optionally can include an anti-reflective coating.

In some embodiments, the remote inspection module optionally can include a camera configured so as to record images of the first array of photovoltaic modules. The camera optionally can be configured to record images of photovoltaic surfaces of the first array of photovoltaic modules. In some embodiments, the system optionally further includes array wiring or a module junction box coupling the photovoltaic modules of the first array to one another. The camera optionally can be configured to record images of the array wiring or module junction box. The optionally camera can include an infrared sensor. The images optionally can include infrared images.

The vehicle optionally further can include a cleaning tool.

The vehicle optionally can include a first set of one or more wheels or tread that travels along the first support surface, and a second set of one or more wheels or tread that travels along the second support surface.

The system optionally further can include a row-to-row mechanism configured to move the first vehicle from the first elongated rail to a second elongated rail.

Optionally, the first and second vehicle support surfaces and the at least one mounting surface can include extruded concrete disposed on the ground.

According to another embodiment, a method for maintaining photovoltaic modules includes providing a first elongated rail including first and second support surfaces and a first mounting surface disposed between the first and second support surfaces, a first array of the photovoltaic modules being coupled to the first mounting surface and raised relative to the first and second support surfaces. The method also can include disposing a first vehicle on the first and second support surfaces. The first vehicle can include a motor; a maintenance module selected from the group consisting of: a spray system configured to spray a product, and a remote inspection module; and first and second support legs. The method also can include suspending the maintenance module relative to the photovoltaic modules of the first array using the first and second support legs, the first and second support legs being movably coupled to the first and second support surfaces so as to laterally and sequentially move the maintenance module in a direction parallel to the first elongated rail responsive to actuation of the motor.

The spray system optionally can include a reservoir storing the product and a spray nozzle coupled to the reservoir and configured to spray the product. The product optionally can include one or more of a protective material, an herbicide, a reflective coating, a dust suppressor, an insecticide, an animal deterrent, or a seed. The product optionally can include a liquid or optionally can include a powder.

The first elongated rail optionally is disposed on an installation surface. The spray nozzle optionally sprays the product on the installation surface. A second elongated rail optionally can support a second array of photovoltaic modules. The spray nozzle optionally sprays the product on a region of the installation surface between the first elongated rail and the second elongated rail. The product optionally can include a reflective coating or optionally can include an herbicide.

The spray nozzle optionally sprays the product on one or more backsheets of the photovoltaic modules of the first array. The product optionally can include a protective material configured so as to improve weatherability of the photovoltaic modules of the first array.

The spray nozzle optionally sprays the product on the first elongated rail. The product optionally can include a protective material configured so as to improve weatherability or sealant to repair one or more cracks in the first elongated rail.

Optionally, array wiring or a module junction box couples the photovoltaic modules of the first array to one another. The spray nozzle optionally sprays the product on the array wiring or the module junction box. The product optionally can include an insulating layer.

Optionally, a plurality of legs couple the photovoltaic modules of the first array to the first mounting surface. The spray nozzle optionally sprays the product on the legs. The product optionally can include an oxidation inhibitor.

The spray nozzle optionally sprays the product on photovoltaic surfaces of the first array of photovoltaic modules. The product optionally can include an anti-reflective coating.

Optionally, the remote inspection module can include a camera configured so as to record images of the first array of photovoltaic modules. The camera optionally records images of photovoltaic surfaces of the first array of photovoltaic modules. Optionally, array wiring or a module junction box couple the photovoltaic modules of the first array to one another. The camera optionally records images of the array wiring or module junction box. The camera optionally can include an infrared sensor. The images optionally include infrared images.

Optionally, the vehicle further can include a cleaning tool.

The vehicle optionally can include a first set of one or more wheels or tread that travels along the first support surface, and a second set of one or more wheels or tread that travels along the second support surface.

Optionally, a row-to-row mechanism moves the first vehicle from the first elongated rail to a second elongated rail.

Optionally, the first and second vehicle support surfaces and the at least one mounting surface include extruded concrete disposed on the ground.

### BRIEF DESCRIPTION OF DRAWINGS

FIG. 1 is a simplified diagram of a conventional photovoltaic array.

FIG. 2 is a simplified diagram of a conventional photovoltaic module.

FIGS. 3A-3D are simplified diagrams showing perspective views of a system and vehicle for maintaining at least one rail based array of photovoltaic modules, according to certain embodiments.

FIGS. 4A-4H are simplified diagrams showing perspective views of a system and vehicle for spraying a product relative to at least one rail based array of photovoltaic modules, according to certain embodiments.

FIG. 5 is a simplified diagram showing a perspective view of a vehicle for remote inspection of at least one rail based array of photovoltaic modules, according to certain embodiments.

FIGS. 6A-6E illustrate exemplary images that can be obtained using a vehicle for remote inspection of at least one rail based array of photovoltaic modules, according to certain embodiments.

FIG. 7 is a simplified diagram showing a perspective view of a vehicle for trimming vegetation relative to at least one rail based array of photovoltaic modules, according to certain embodiments.

FIG. 8 illustrates steps in an exemplary method for maintaining at least one rail based array of photovoltaic modules, according to certain embodiments.

FIGS. 9A-9B are simplified diagrams showing perspective views of an optional cleaning head and actuator in a first position, according to certain embodiments.

FIG. 10A-10C are simplified diagrams showing perspective views of an optional cleaning head and actuator in a second position, according to certain embodiments.

FIG. 11A is a simplified diagram showing a perspective view of an exemplary rail-to-rail mechanism for moving a maintenance vehicle from a first rail based array of photovoltaic modules to a second rail based array of photovoltaic modules, according to certain embodiments.

FIG. 11B is a simplified diagram showing a perspective view of another exemplary rail-to-rail mechanism for moving a maintenance vehicle from a first rail based array of photovoltaic modules to a second rail based array of photovoltaic modules, according to certain embodiments.

FIG. 11C is a simplified diagram showing a perspective view of yet another exemplary rail-to-rail mechanism for moving a maintenance vehicle from a first rail based array of photovoltaic modules to a second rail based array of photovoltaic modules, according to certain embodiments.

FIG. 12 illustrates steps in an exemplary method for maintaining at least one rail based array of photovoltaic modules, according to certain embodiments.

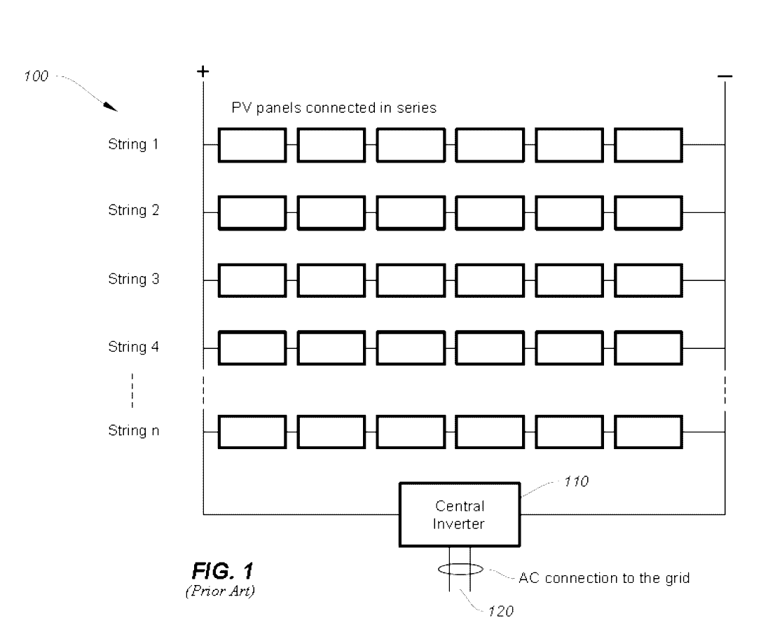

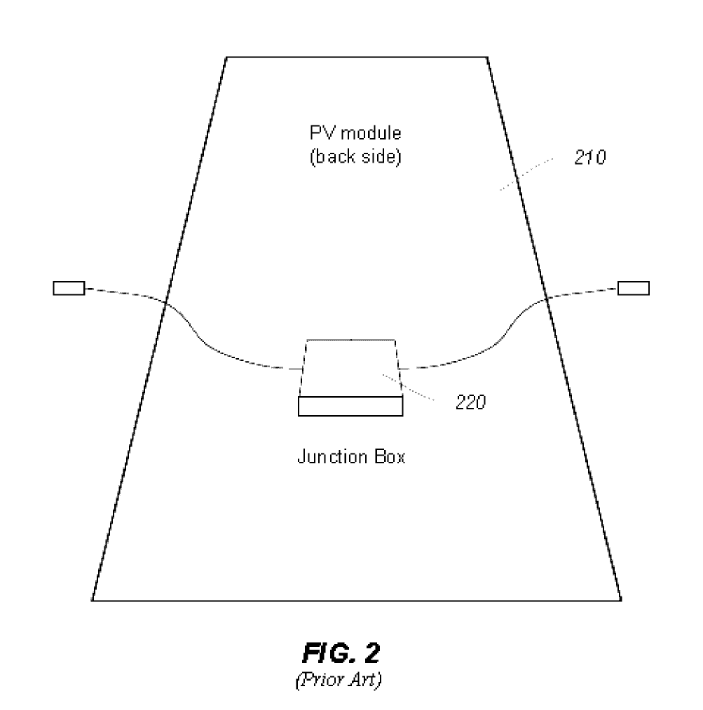

### DETAILED DESCRIPTION

The present invention is directed to photovoltaic modules according to certain embodiments. More particularly, some embodiments of the invention provide systems, vehicles, and methods for maintaining rail-based arrays of photovoltaic modules. Merely by way of example, embodiments of the invention have been applied to cleaning rail-based arrays of photovoltaic modules. However, it would be recognized that the invention has a much broader range of applicability.

For example, it should be understood that the following embodiments and figures are provided purely as examples, and are not intended to be limiting. Additionally, it should be understood that any suitable combination of features can be combined with one another. In some embodiments SPOT maintenance vehicle (which also can be referred to, e.g., as SPOT robot, or maintenance vehicle) can increase the efficiency and/or can extend the lifetime of a solar (e.g., photovoltaic) power plant, such as by providing one or more of the following features:
Performing automated cleanings so as to reduce dirt on solar (e.g., photovoltaic) modules, e.g., so as to keep solar modules dirt-free and producing power efficiently;
Vegetation management;
Acting as a remote data collection and monitoring platform for power plant operators; and/or
Applying protective coatings to one or more power plant components, e.g., through a spray system.

Additionally, or alternatively, the SPOT maintenance vehicle (e.g., SPOT robot) can provide:
The application of one or more products to the area between rows of solar panels or on either side of a row of solar panels, e.g., between tracks (elongated rails) or on either side of a track. Exemplary products can include one or more of the following: herbicide, reflective coating, dust suppressors, insecticides, animal deterrents, and/or seeds for preferred vegetation.

It should be appreciated that the present systems, vehicles, and methods can provide any suitable combination of one or more of the following: increased power generation efficiency, increased lifetime of photovoltaic system components, and/or improved system installation and use in harsher or more extreme environments, e.g., dustier, more vegetation growth, areas with corrosive materials present, and/or presence of animals that can damage the system, than may be achieved without the use of the present systems, vehicles, and methods. As such, the present systems, vehicles, and methods can expand the market for photovoltaic power.

Illustratively, the rail-based arrays of photovoltaic modules with which the present systems, vehicles, and methods can be used can, in some embodiments, include an elongated rail including first and second support surfaces and a first mounting surface disposed between the first and second support surfaces. An array of the photovoltaic modules can be coupled to the first mounting surface and raised relative to the first and second support surfaces. Optionally, a plurality of such rails can be provided, and a corresponding array of photovoltaic modules can be coupled to at least one mounting surface of each such rail. For further details on exemplary rail-based arrays of photovoltaic modules, see commonly assigned U.S. Pat. No. 9,462,734 and U.S. Patent Publication No. 2013/0068275, the entire contents of both of which are incorporated by reference herein.

Under one aspect of the present invention, a maintenance vehicle can be configured to be disposed on the first and second support surfaces of the elongated rail. The maintenance vehicle can include a maintenance module, such as a spray system configured to spray a product, a remote inspection module, or a vegetation cutter, a motor, and first and second support legs. In certain, non-limiting embodiments, the maintenance vehicle can be configured so as substantially to be supported only by the first and second support surfaces, rather than being supported by the photovoltaic modules themselves. As such, the maintenance vehicle can be moved along the array so as to move the maintenance module relative to the photovoltaic modules of the array, without the maintenance module imposing a significant load or torque on the photovoltaic modules themselves. In embodiments where the maintenance module includes a spray system, the spray system can be configured so as to spray a suitable product on any suitable component relative to the elongated rail and/or photovoltaic modules of the array. In embodiments where the maintenance module includes a remote inspection module, the remote inspection module can be configured so as to record images of any suitable component relative to the elongated rail and/or photovoltaic modules of the array. In embodiments where the maintenance vehicle includes a vegetation cutter, the cutter can be configured so as to trim vegetation that may grow relative to the elongated rail and/or photovoltaic modules of the array. Optionally, the vehicle further can include a cleaning head, and can be moved along the array so as to clean the photovoltaic modules of the array, without imposing a significant load or torque on the photovoltaic modules themselves other than that associated with cleaning the modules, e.g., with a rotating brush that can be lowered into contact with the modules.

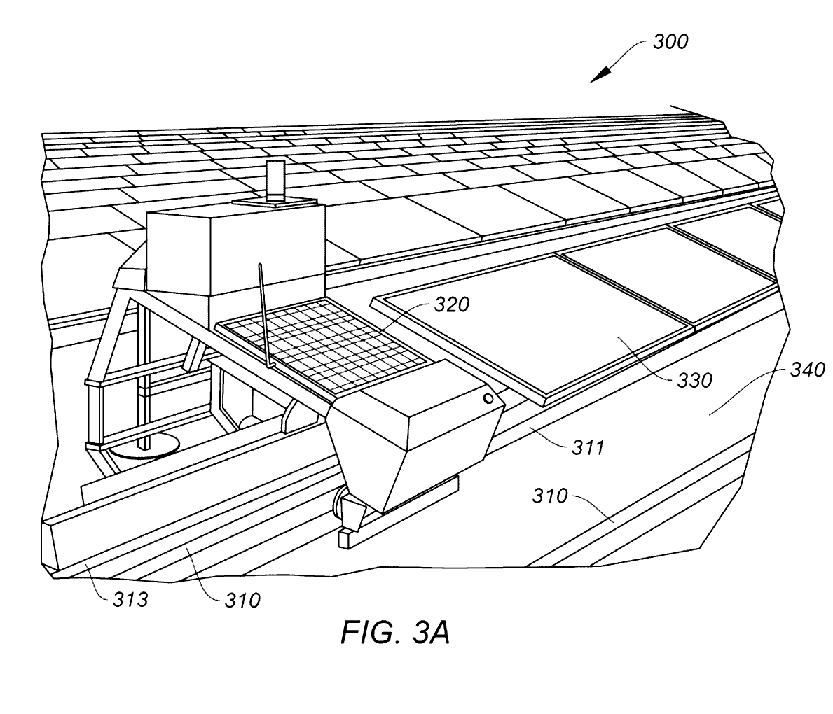

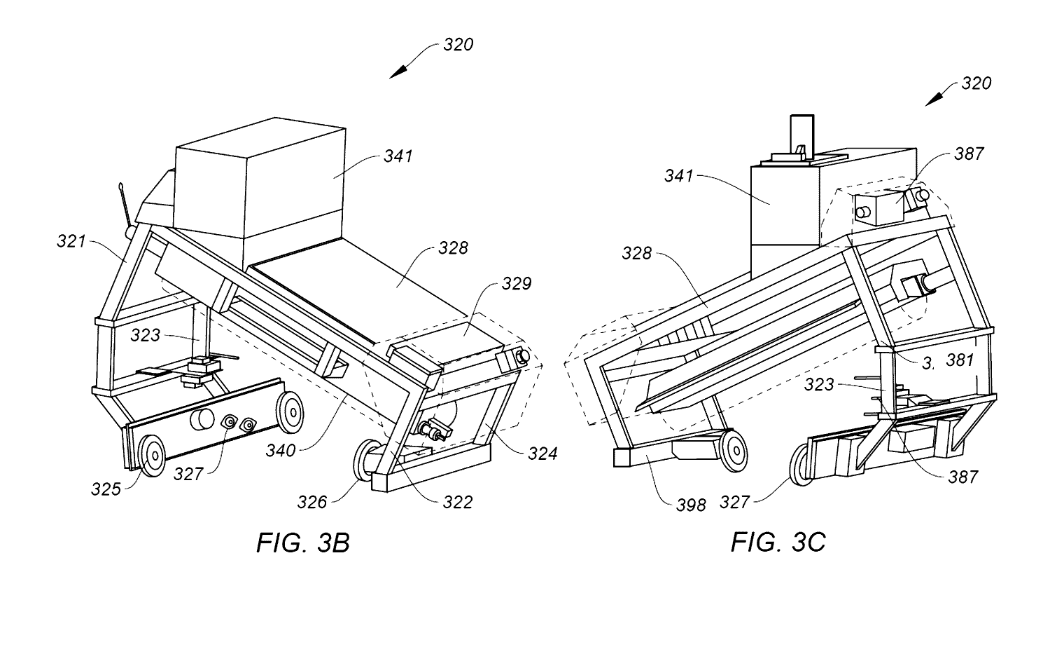

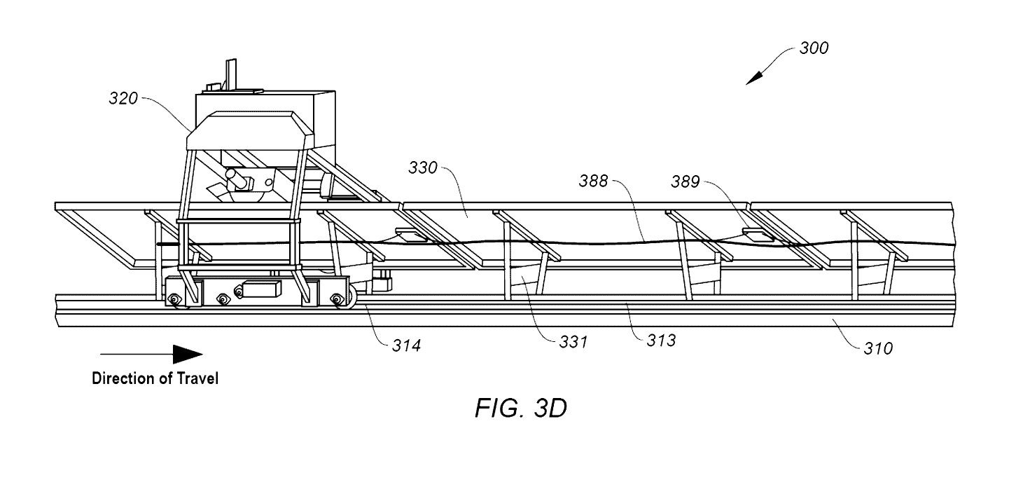

FIGS. 3A-3D are simplified diagrams showing perspective views of a system and vehicle for maintaining at least one rail based array of photovoltaic modules, according to certain embodiments. These diagrams are merely an example, which should not unduly limit the scope of the claims. One of ordinary skill in the art would recognize many variations, alternatives, and modifications. For example, exemplary configurations of one non-limiting example of a SPOT maintenance vehicle are illustrated in FIGS. 3A-3D, and more particularly in FIGS. 3B-3C. It should be understood that any suitable combination of such components can be included. For example, one or more components are modified. In another example, one or more components are removed. In yet another example, one or more components are added.

System 300 illustrated in FIGS. 3A-3D includes elongated rail 310 and maintenance vehicle 320 for maintaining photovoltaic modules 330, such as solar panels. Elongated rail 310 can include one or more mounting surfaces, e.g., mounting surface 313, that can serve as a mechanical substrate for mounting an array of photovoltaic modules 330. For example, as can be seen in FIG. 3D, photovoltaic module 330 can include one or more legs 331 that couple to the one or more mounting surfaces 313 of elongated rail 310. For example, photovoltaic module 330 can include at least one leg that engages a first recess defined in elongated rail 310 that defines a first mounting surface 313, and at least one leg that engages a second recess defined in elongated rail 310 that defines a second mounting surface 313. Optionally, the one or more legs are coupled to the one or more mounting surfaces using adhesive. Illustratively, the PV modules 330 can be or can include a glass-to-glass module. Additionally, or alternatively, the one or more mounting surfaces of elongated rail 310 or the legs 331 of photovoltaic module 330, or both, can be configured such that the photovoltaic module is disposed at a tilt angle. For example, the tilt angle varies depending upon the geographic location (e.g., latitude or orientation) of the photovoltaic module 330 so as to enhance the modules' energy capture from the light source (e.g., the sun). System 300 further can include array wiring 388 and/or module junction box 389 coupling photovoltaic modules 330 to one another electrically, e.g., in a manner such as shown in FIG. 3D. Such array wiring 388 and/or module junction box 389 can, for example, be disposed on the underside of photovoltaic modules 330, e.g., so as not to obstruct sunlight from irradiating photovoltaic surfaces of the photovoltaic modules.

Elongated rail 310 also can include one or more support surfaces, e.g., support surfaces 313 and 314, that can serve as a mechanical support for maintenance vehicle 320 such that the maintenance vehicle can move along and in a direction parallel to the elongated rail, e.g., while maintaining photovoltaic modules 330. In the illustrated embodiment, the one or more mounting surfaces, e.g., one or more mounting surfaces 313, are disposed between the one or more support surfaces, e.g., support surfaces 313 and 314. Additionally, or alternatively, photovoltaic modules 330 are raised relative to the one or more support surfaces, e.g., support surfaces 313 and 314. Optionally, first and second vehicle support surfaces 313, 314 and the at least one mounting surface, e.g., one or more mounting surfaces 311, are integrally formed with one another of a common material shaped so as to define each such surface. Additionally, or alternatively, the first and second vehicle support surfaces and the at least one mounting surface can be integrally formed of extruded concrete disposed on the installation surface, e.g., ground 340. In one example, elongated rail 310 is constructed from concrete, or is constructed on site (e.g., being extruded in place using a slip-form extrusion machine), or both.

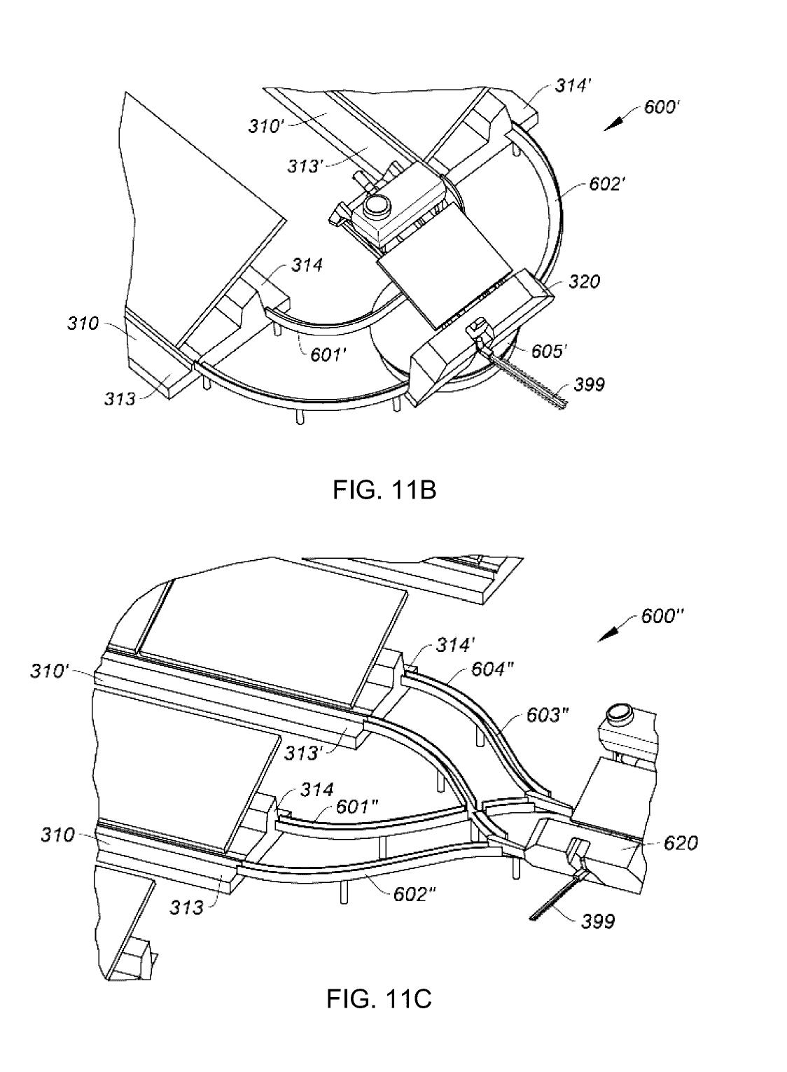

Optionally, a plurality of elongated rails 310 optionally can be provided, each including one or more mounting surfaces to which photovoltaic modules 330 can be coupled, and one or more support surfaces that can serve as a mechanical support for maintenance vehicle 320. As described in greater detail below with reference to FIGS. 11A-11C, the same maintenance vehicle 320 can be used to maintain the photovoltaic modules 330 coupled to those elongated rails 3100; alternatively, a different maintenance vehicle 320 can be provided corresponding to each elongated rail so as respectively to maintain the photovoltaic modules coupled to only one of such rails. For example, in one embodiment, one vehicle is used per row of solar panels. In yet another embodiment, one maintenance vehicle is moved between rows by mechanism. In yet another example, the maintenance vehicle uses one or more limit switches to detect end-of-row.

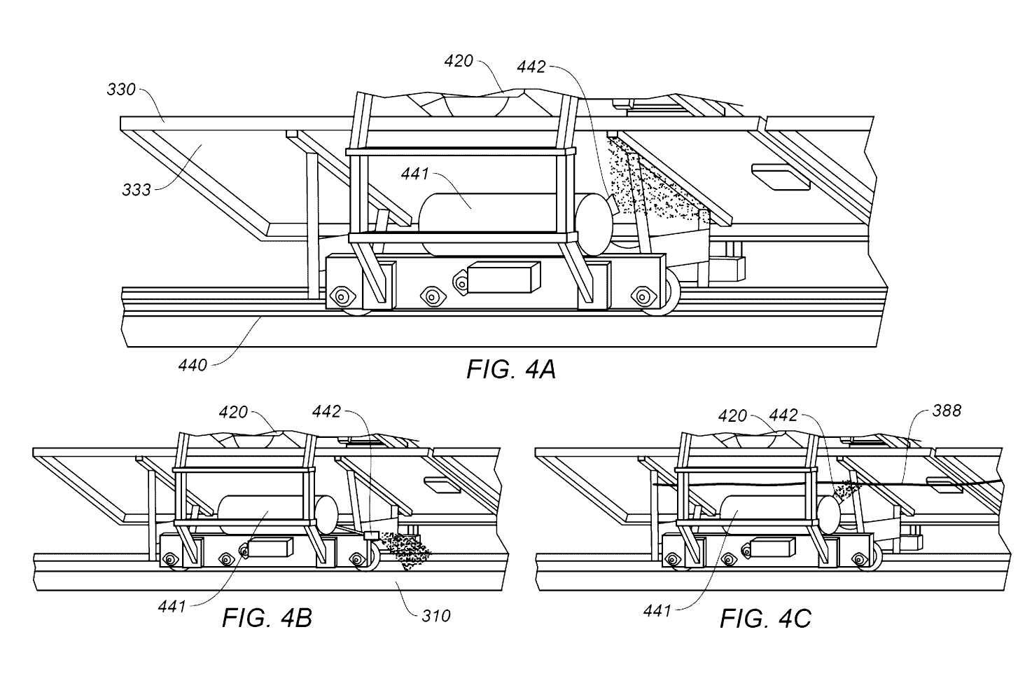

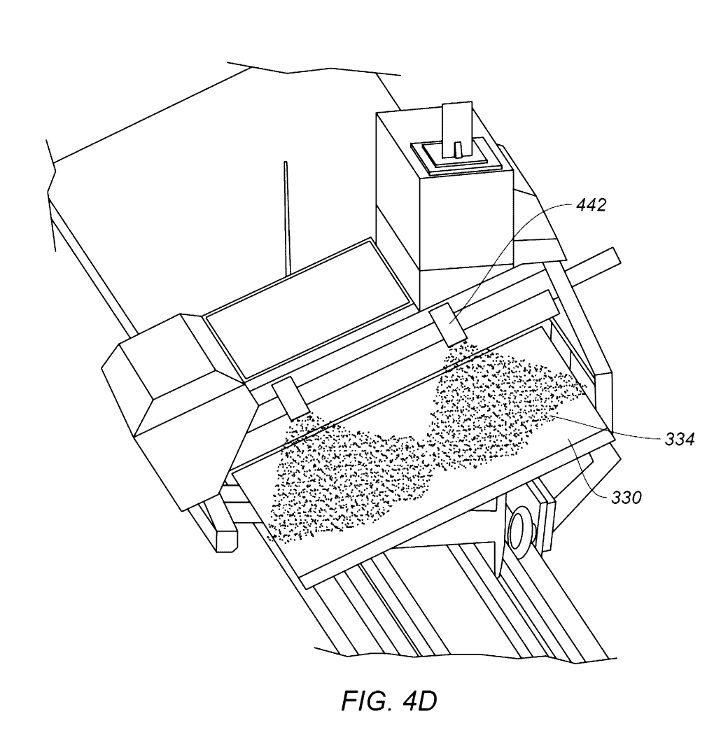

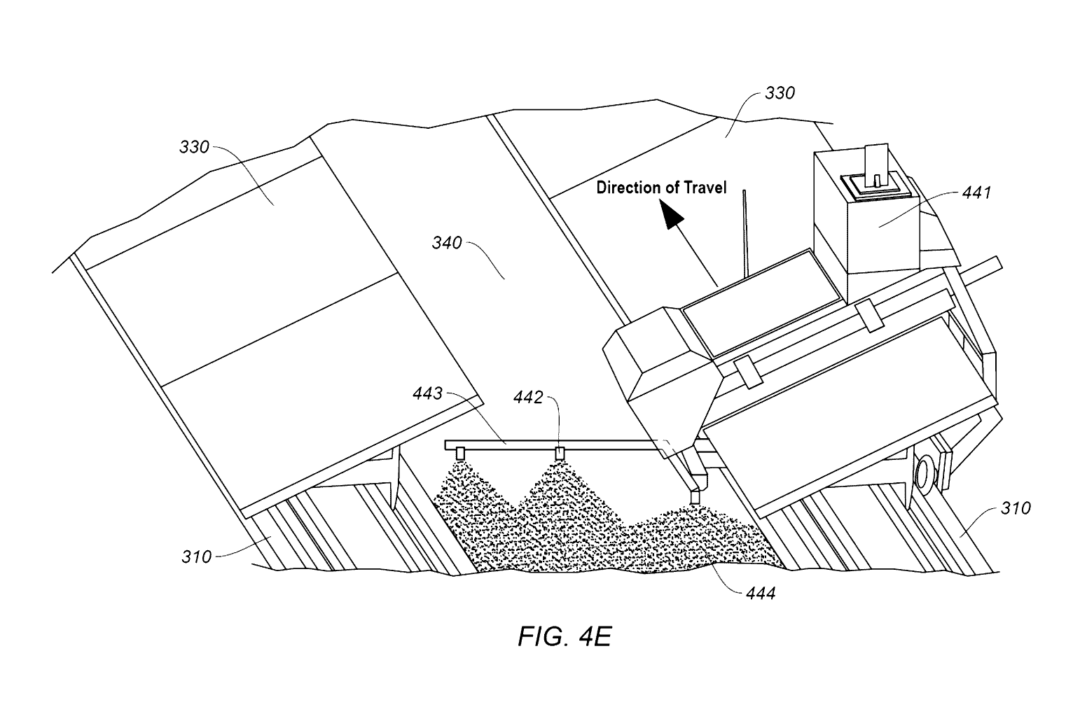

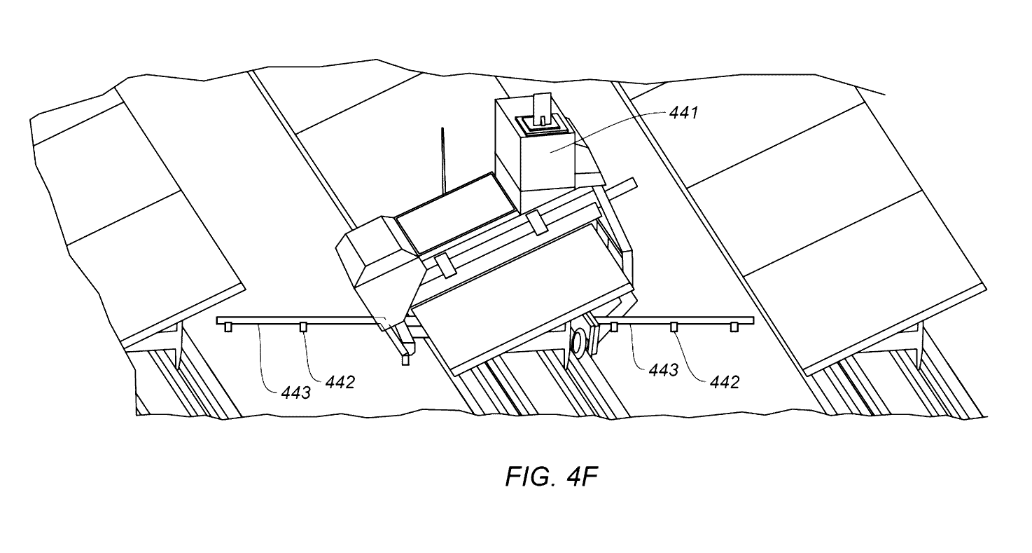

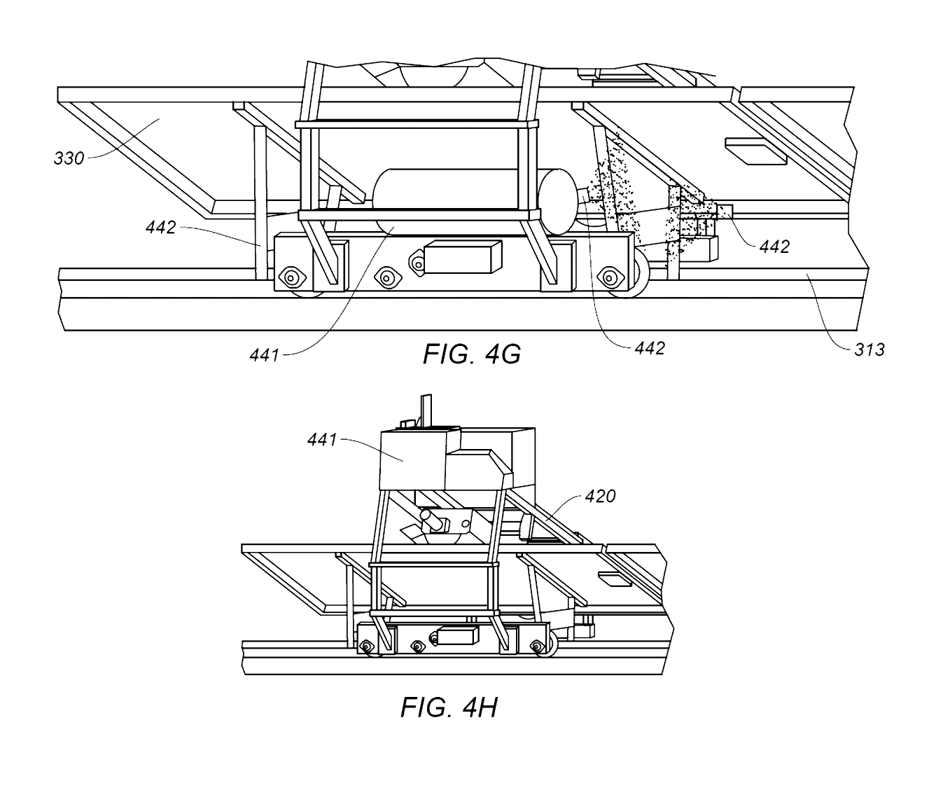

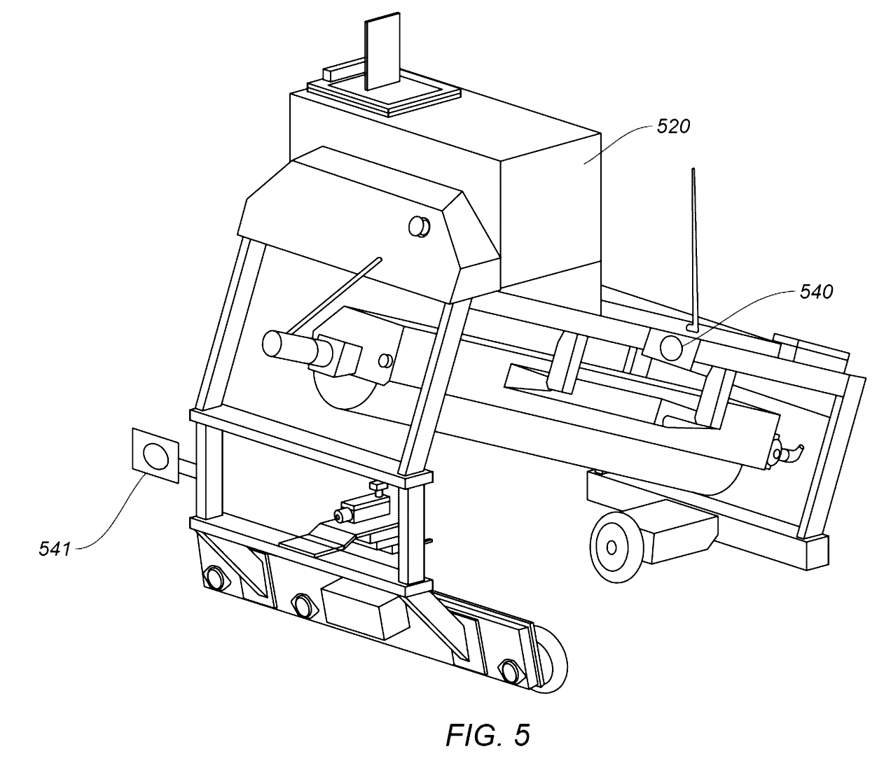

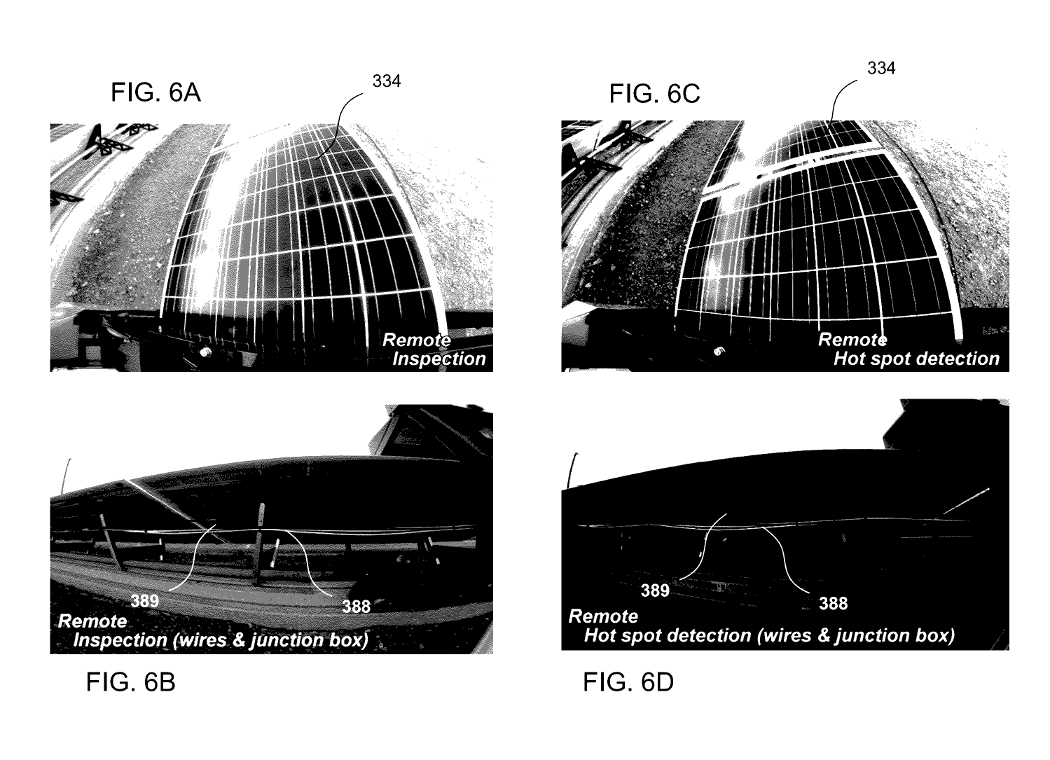

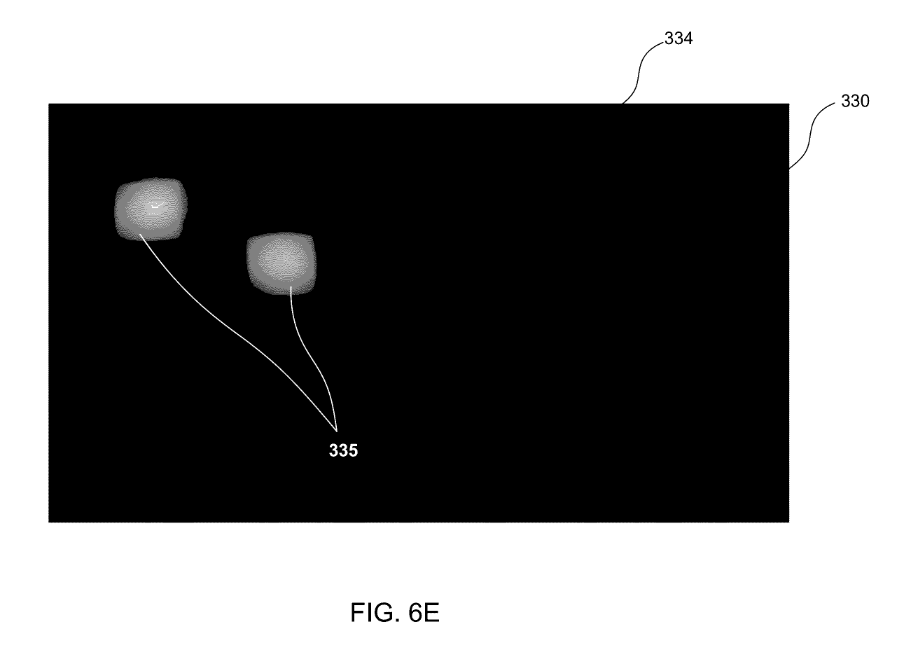

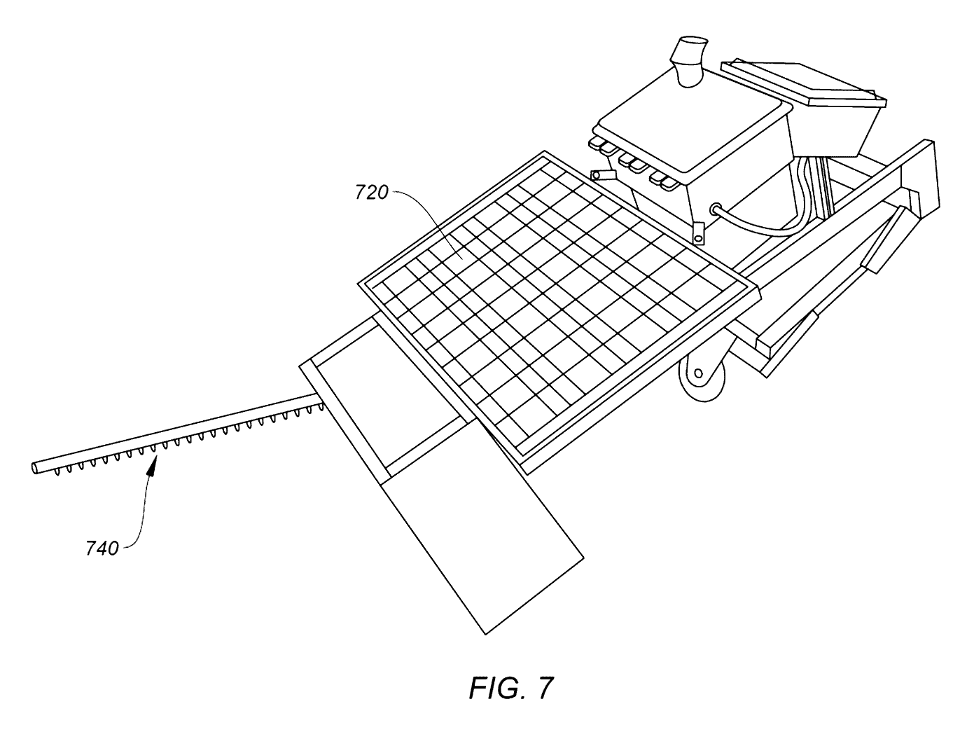

In some configurations, maintenance vehicle 340 includes a maintenance module, such as a spray system that optionally can be configured in a manner such as described herein with reference to FIGS. 4A-4H, a remote inspection module that optionally can be configured in a manner such as described herein with reference to FIGS. 5 and 6A-6E, and/or a cutting head that optionally can be configured in a manner such as described herein with reference to FIG. 7.

Additionally, in some embodiments, the SPOT maintenance vehicle rests on and travels along a concrete track that one or more solar modules are mounted on. For example, the SPOT maintenance vehicle includes a first set of one or more wheels (shown in some or all of FIGS. 3A-3D) or tread that travels along a first surface of the concrete track, and a second set of one or more wheels (shown in some or all of FIGS. 3A-3D) or tread that travels along a second surface of the concrete track.

For example, as illustrated in FIGS. 3A-3D, maintenance vehicle 320 for photovoltaic modules 330, such as solar panels, is disposed on and movably coupled to the one or more support surfaces of elongated rail 310, e.g., can be disposed on first support surface 313 and second support surface 314. For example, the maintenance vehicle rolls on an extruded concrete rail. Maintenance vehicle 320 can include a chassis 398 including one or more support legs, e.g., first and second support legs 321 and 322, and optionally can include three or more support legs, e.g., first support leg 321, second support leg 322, third support leg 323, and fourth support leg 324, as shown in the exemplary embodiment illustrated in FIGS. 3A-3D. The one or more support legs respectively can be coupled to one or more wheels, caterpillar treads, or the like permitting locomotion of maintenance vehicle 320 along the one or more support surfaces of elongated rail 310 in a direction parallel to the elongated rail. For example, in the embodiment illustrated in FIGS. 3A-3D, support leg 321 can be coupled to one or more wheels 325 that are movably disposed on, e.g., can contact and move along, first support surface 313, and support leg 322 can be coupled to one or more wheels 326 that are movably disposed on, e.g., can contact and move along, second support surface 314. In one illustrative embodiment, maintenance vehicle 320 further can include a third support leg, e.g., leg 323, that is movably coupled to one of the first and second support surfaces 313, 314, e.g., by a third wheel 327 that is movably disposed on, e.g., can contact and move along, that support surface. In one nonlimiting example, elongated rail 310 includes concrete.

In yet another example, the maintenance vehicle 320 includes one or more adjustable frames to accommodate one or more panel angles. For example, in some embodiments, at least one of the support legs 321, 323 is adjustable so as to accommodate photovoltaic modules at different angles than one another. For example, in the embodiment illustrated in FIGS. 3A-3D, support legs 321, 323 each can include a joint 381 the angle of which can be increased or decreased (e.g., automatically with an actuator, not illustrated or manually) so as to modify the relative angle of one or more portions of maintenance vehicle 320 relative to photovoltaic modules 330. For example, photovoltaic modules 330 can have a fixed angle or can be dynamically adjustable so as to track the sun over the course of the day. Joint 381 can be adjusted so as to modify the relative angle of one or more portions of maintenance vehicle 320 based on a fixed angle of photovoltaic modules 330 or based on an angle at a given time of dynamically adjustable photovoltaic modules 330.

Maintenance vehicle 320 also can include first motor 327 (drive system) configured to laterally and sequentially move the vehicle in a direction parallel to elongated rail 310 and relative to each of the photovoltaic modules 330 in the array responsive to actuation of first motor 327. First motor 327 can be powered by any suitable fuel source, e.g., can include a combustion motor, an electric motor, or the like. Optionally, first motor 327 can include a plurality of motors, each configured so as to drive one or more of wheels 325, 326, and/or 327. In one nonlimiting example, first motor 327 optionally can include one motor per wheel. In one example, the maintenance vehicle is charged by one or more solar panels. For example, in the embodiment illustrated in FIGS. 3A-3D, maintenance vehicle 320 further can include a power source such as solar panel 328 and/or a battery 329 configured to provide power to first motor 327, and optionally also to one or more other motors or actuators of vehicle 320 such as those described elsewhere herein. In one embodiment, solar panel 328 is operably coupled to battery 329 so as to charge the battery and optionally also provide power to maintenance vehicle 320 during daylight hours, and then battery 329 can continue to provide power to maintenance vehicle 320 at times when solar panel 328 provides insufficient power, e.g., during nighttime hours. Illustratively, maintenance vehicle 320 can include control(s) 387 to which motor 327, maintenance module, and/or optional cleaning head 340 can be coupled via a motor control cable (cable not shown in FIGS. 3A-3D). In one embodiment, the maintenance vehicle 320 is dispatched by wireless control. For example, the wireless control is managed by web interface. Illustratively, the controller of maintenance vehicle 320 can be in wired or wireless communication with a remote computer via which a user can enter commands to maintenance vehicle 320, e.g., by a web interface. Such wireless communication with a remote computer can utilize, for example, WiFi, WiMax, Bluetooth, a cellular connection, or other suitable wireless connection. In one illustrative embodiment, maintenance vehicle 320 includes cutting head 399 such as illustrated in FIGS. 11A-11C.

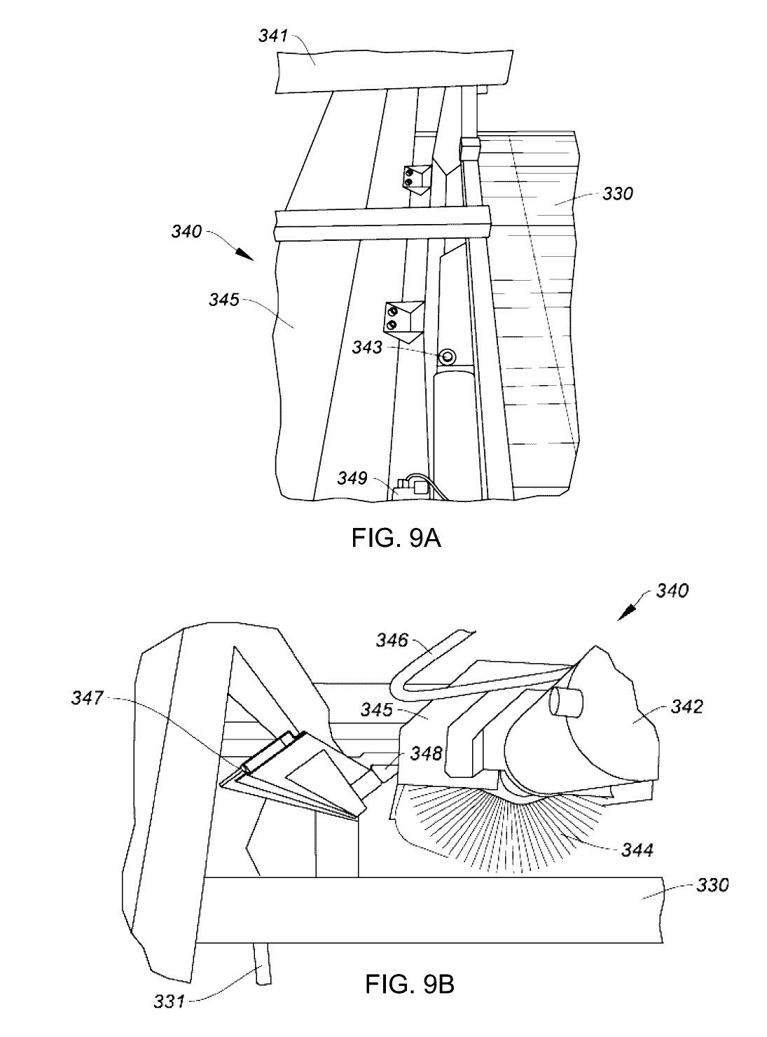

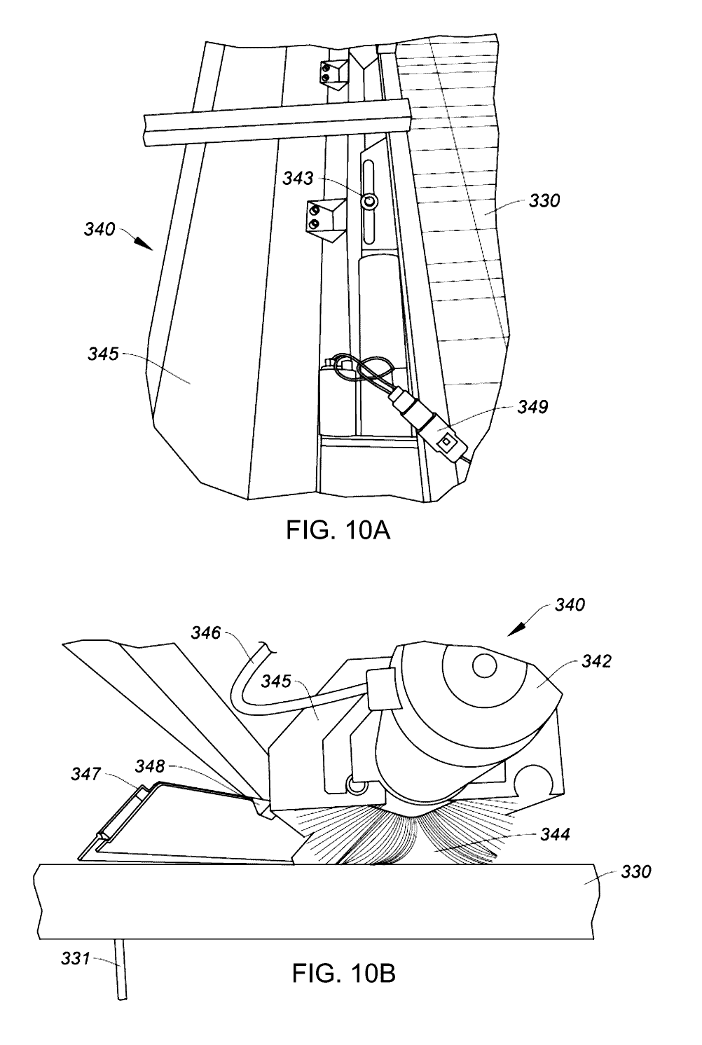

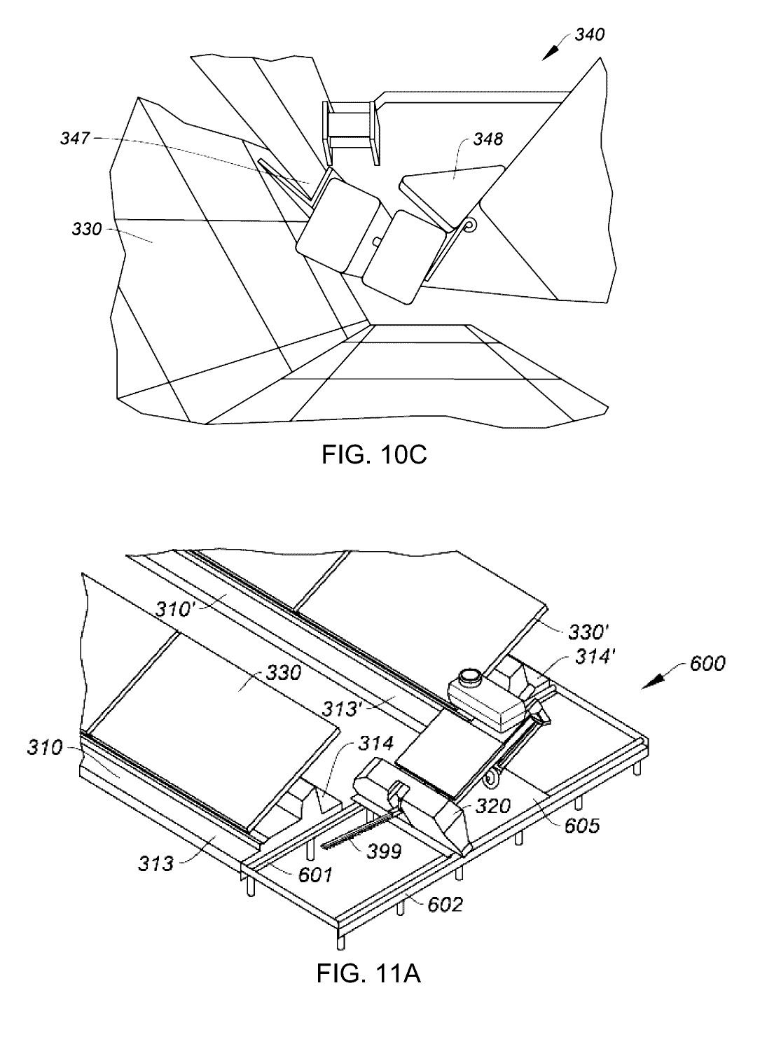

Maintenance vehicle 320 optionally also can include cleaning head 340 such as described in greater detail with reference to FIGS. 9A-10C. In certain, non-limiting embodiments, the first and second support legs can suspend the cleaning head over the photovoltaic modules of the array. First and second support legs 321, 322 of maintenance vehicle 320 can movably couple cleaning head 340 to the one or more support surfaces 313, 314 of elongated rail 310 such that the cleaning head can be laterally and sequentially moved in a direction parallel to the elongated rail and across each of the photovoltaic modules 330 of the array responsive to actuation of motor 327. Additionally, as described in greater detail with reference to FIGS. 9A-10C, at least a portion of optional cleaning head 340 optionally can be vertically movable between a disengaged position spaced apart from photovoltaic modules 330 of the array and one or more engaged positions in contact with at least one of the photovoltaic modules of the array responsive to actuation of an actuator. In one nonlimiting, illustrative embodiment, at least a portion of cleaning head 340 has a substantially fixed position relative to first and second support legs 321, 322, and at least a portion of cleaning head 340 is vertically movable relative to other portions of cleaning head 340 and relative to one or more photovoltaic modules 330. In other embodiments, the entirety of cleaning head 340 is vertically movable relative to first and second support surfaces 313, 314 and relative to one or more photovoltaic modules 330. In still other embodiments, cleaning head 340 has a substantially fixed position relative to first and second support legs 321, 322.

As described in greater detail with reference to FIGS. 9A-10C, optional cleaning head 340 can include a second motor, and the at least a portion of cleaning head 340 can include a brush movable to contact at least one of the photovoltaic modules 330 of the array in at least one engaged position responsive to actuation of an actuator (second motor, brush, and actuator not specifically shown in FIGS. 3A-3D). The brush can be rotatable along an axis parallel to the photovoltaic modules 330 of the array responsive to actuation of the second motor. Additionally, or alternatively, and in certain embodiments, such as illustrated in FIGS. 3A-3D, optional cleaning head 340 can include fluid reservoir 341 and a second actuator (actuator not shown in FIGS. 3A-3D). Optional cleaning head 340 can be operable to dispense fluid from the fluid reservoir 341 onto at least one of photovoltaic modules 330 of the array responsive to actuation of the second actuator. In one example, the maintenance vehicle 320 uses gravity fed water. Optionally, as described with reference to FIGS. 9A-10C, optional cleaning head 340 can include a wiper in contact with at least one photovoltaic module 330 of the array when the at least a portion of the first cleaning head is in an engaged position, and operable to at least partially dry that photovoltaic module.

In yet another embodiment, the maintenance vehicle 320 includes one or more trimmer mechanisms to remove vegetation. Exemplary trimmer mechanisms suitable for use in maintenance vehicle 320 include string trimmers, hedge trimmers, pole saws, tillers, harrows, plows, and the like (not specifically illustrated in FIGS. 3A-3D, but optionally configured similarly as described below with reference to FIG. 7), and can be powered by electricity or combustion, or by the motion of maintenance vehicle 320.

Details of exemplary configurations of a maintenance vehicle including a maintenance module, and operation thereof, now will be described with reference to FIGS. 4A-4H, 5, 6A-6E, 7, and 8. The maintenance vehicle can include legs suspending the maintenance module relative to the photovoltaic modules of the array and being movably coupled to support surfaces of an elongated rail, so as to laterally and sequentially move the maintenance module in a direction parallel to the elongated rail responsive to actuation of a motor of the vehicle.

For example, FIGS. 4A-4H are simplified diagrams showing perspective views of a system and vehicle for spraying a product relative to at least one rail based array of photovoltaic modules, according to certain embodiments. In some embodiments, the SPOT maintenance vehicle can be configured so as to apply one or more protective coatings to one or more power plant components. For example, the SPOT maintenance vehicle includes a spray nozzle coupled to a source of the protective coating. In another example, the SPOT maintenance vehicle includes a storage tank holding the protective coating in liquid form, or in powder form. The non-limiting, exemplary configuration such as illustrated in FIG. 4A can facilitate the application of silicone and/or another protective material to one or more solar module backsheets, e.g., so as to improve weatherability. For example, sand, wind, heat, and/or hot/cold cycles in the environment can degrade coatings such as used in a photovoltaic module and/or system. It can be useful to repair a coating or to apply a new coating without needing to detach or move the photovoltaic module. In the example shown in FIGS. 4A-4H, maintenance vehicle 420 can be configured similarly as vehicle 320 described herein with reference to FIGS. 3A-3D, and can include a maintenance module including spray system 440 configured to spray a product relative to the photovoltaic modules, e.g., while vehicle 420 moves laterally and sequentially relative to such modules so as to move the maintenance module laterally and sequentially relative to such modules. Spray system 440 can include reservoir 441 storing the product and spray nozzle 442 configured to spray the product. Illustratively, the product can include one or more of a protective material, an herbicide, a reflective coating, a dust suppressor, an insecticide, an animal deterrent, or a seed. Such products can be commercially available, and some examples of commercially available products suitable for use with the present spray system are described further below. In some configurations, the product can include a liquid. In some configurations, the product can include a powder.

It should be appreciated that spray system 440 can be configured so as to spray the product relative to any suitable portion of the system. For example, in the configuration illustrated in FIG. 4A, spray nozzle 442 is configured so as to spray the product on one or more backsheets 333 of the photovoltaic modules 330 of the array. The “backsheet” of a photovoltaic module can be considered to be all or a portion of the major surface of the photovoltaic module that is opposite to the photovoltaic surface of the module. The product can include a protective material configured so as to improve weatherability of the photovoltaic modules of the array. For example, the product can include silicone or another material that adheres to the backsheet so as to create a barrier, film, or coating that inhibits contact between moisture and module 330. An exemplary protective material suitable for use in improving weatherability of photovoltaic modules 330 is TECHSPRAY Silicone Conformal Coating, e.g., Fine-L-Kote SR Silicone Conformal Coating (commercially available from TECHSPRAY, Kennesaw, Ga.).

In some embodiments, one or more spray nozzles are positioned so as to direct the application of one or more protective materials to the concrete track, e.g., elongated rail. Non-limiting examples of products that can be applied include coatings to improve weatherability and/or one or more sealants to repair one or more cracks in the concrete track, e.g., elongated rail. For example, in the configuration shown in FIG. 4B, spray nozzle 442 is configured so as to spray the product on elongated rail 310. The product can include a protective material configured so as to improve weatherability or sealant to repair one or more cracks in the elongated rail. An exemplary protective material suitable for use in improving weatherability or sealant to repair one or more cracks in the elongated rail is SPRAY-TEK Acrylic Overlay (commercially available from Concrete Coatings, Inc., Layton, Utah).

In some embodiments, one or more spray nozzles are positioned so as to direct spray onto one or more electrical wires that, for example, are mounted to one or more module support legs. In certain embodiments, one or more materials are applied to the one or more electrical wires to protect one or more existing insulating layers and/or add one or more new layers. Also, in some embodiments, spray alternatively, or also, is directed at one or more module junction boxes. For example, in the configuration shown in FIG. 4C, the system further includes array wiring 388 and/or module junction box 389 coupling the photovoltaic modules 330 of the array to one another, and spray nozzle 442 is configured so as to spray the product on the array wiring or the module junction box (module junction box 389 not specifically shown in FIG. 4C but can be configured such as described herein with reference to FIGS. 3A-3D). The product can include an insulating layer. An example insulating layer suitable for use in protecting one or more existing insulating layers and/or adding one or more new layers to one or both of array wiring 388 and/or module junction box 389 is SPRAYON Red Insulating Varnish (commercially available from SPRAYON, a company of Sherwin-Williams, Cleveland, Ohio). Another exemplary protective material suitable for use in protecting module junction box 389, e.g., improving weatherability of module junction box 389, is TECHSPRAY Silicone Conformal Coating, e.g., Fine-L-Kote SR Silicone Conformal Coating (commercially available from TECHSPRAY, Kennesaw, Ga.).

In some embodiments, one or more spray nozzles are positioned so as to direct spray onto one or more photovoltaic surfaces. For example, in the configuration shown in FIG. 4D, spray nozzle 442 is configured so as to spray the product on photovoltaic surfaces 334 of the array of photovoltaic modules 330. Any suitable number of spray nozzles 442 can be included, e.g., so as to spray the product relatively evenly across photovoltaic surfaces 334. Illustratively, a plurality of spray nozzles 442 can be included, such as two spray nozzles. In one example, the product can include an anti-reflective coating, e.g., so as to reduce the reflection of light from photovoltaic surfaces 334. An example anti-reflective coating suitable for use in being sprayed on photovoltaic surfaces 334 is SOLARC Anti-Reflective Coating for Photovoltaic Modules (commercially available from Honeywell Electronic Materials, Sunnyvale, Calif.).

In some embodiments, the SPOT maintenance vehicle includes a spray system for applying products to the area between concrete tracks, e.g., elongated rails. For example, the SPOT maintenance vehicle can include a spray nozzle coupled to a source of a product to be sprayed, such as a storage tank or reservoir configured to hold the product in liquid form, or powdered form. The non-limiting, exemplary configuration such as illustrated in FIG. 4E can facilitate the application of a product to a desired area, such as an area between tracks, e.g., elongated rails. For example, in the configuration shown in FIG. 4E, elongated rail 310 is disposed on an installation surface 340 (e.g., the ground), and spray nozzle 442 is configured so as to spray the product on the installation surface. The system optionally further can include a second elongated rail 310 supporting a second array of photovoltaic modules 330, wherein the spray nozzle is configured so as to spray the product on a region of the support surface 340 between the elongated rails 310. Illustratively, one or more spray nozzles 442 (e.g., a plurality of spray nozzles 442, such as two spray nozzles) can be coupled to a storage tank for spray system product, e.g., reservoir 441, via spray system manifold 443. FIG. 4E further illustrates product 444 being sprayed on the installation surface 340, e.g., a white reflective coating, an herbicide, or other sprayable beneficial material that has been applied. Other exemplary products are described in greater detail herein.

In some embodiments, the spray system can be on the front of SPOT maintenance vehicle as shown in FIG. 4E, or on the front and back as shown in FIG. 4F. The spray nozzles 442 can be mounted in any suitable configuration or location. For example, multiple manifolds 443 can be provided, each of which includes one or more, two or more, or any suitable number of spray nozzles 442. The source, e.g., storage tank or reservoir 441, can be mounted in any suitable configuration or location.

In a non-limiting example, the spray system for applying products to the installation (e.g., ground) surface between tracks (e.g., elongated rails), or on either side of the tracks, such as described herein with reference to FIGS. 4E-4F, can be used to apply one or more of the following products in any suitable location, such as to the ground surface on either side of or between tracks:
Reflective coating, e.g., white reflective coating. For example, the coating can reflect sunlight and/or can increase the amount of ambient light available for the solar panels. Such reflection and/or increase in the amount of ambient light can increase the power production of the solar plant. In one nonlimiting example, the product includes a liquid, e.g., water based paint (e.g., white paint) which optionally can be diluted or a liquid based lime product, or such as a powder based coating, e.g., orchard lime. An exemplary product that can increase ambient light (e.g., provide albedo) in the present systems is Hydrated Lime (commercially available from Texas Lime Company, Cleburne, Tex.).
Herbicide. For example, the herbicide can help to control the growth of vegetation that otherwise could potentially shade the solar panels and/or reduce power production of the solar plant. An exemplary product that can control the growth of vegetation in the present systems is TRIMEC Classic Brand Broadleaf Herbicide (commercially available from PBI Gordon Corporation, Kansas City, Mo.).
Dust suppressor. For example, the dust suppressor can reduce soiling of the solar panels and/or can reduce required cleaning frequency, e.g., so as to maintain a desired power production. An exemplary product that can suppress dust in the present systems is 3M 6837 Dust Control Spray (commercially available from The 3M Company, St. Paul, Minn.).
Insecticide. For example, the insecticide can reduce or minimize the presence of insects that otherwise could harm power plant personnel and/or damage power plant equipment and/or materials. An exemplary product that can reduce or minimize the presence of insects in the present systems is CONQUER Liquid Insecticide (commercially available from Paragon Professional Pest Control Products, Memphis, Tenn.).
Animal deterrents. For example, animal deterrents can deter or keep away animals that otherwise could harm power plant personnel, damage power plant equipment and/or materials, and/or otherwise interfere with power plant operations. An exemplary product that can deter or keep away animals in the present systems is Repels All Animal Repellant Concentrate (commercially available from Bonide Products, Inc., Oriskany, N.Y.).
Solutions containing seeds for desirable vegetation. For example, the seeds can be for desirable vegetation such as short grass that could suppress the growth of weeds that otherwise could shade solar panels and/or reduce power production of the solar plant. An example of seeds that can be applied to the installation surface (e.g., ground) in the present systems is HYDRO MOUSSE Liquid Lawn (commercially available from Eagle Eye Marketing Group, Inc., Toronto, Canada).

In some embodiments, one or more spray nozzles (e.g., two spray nozzles) are positioned so as to direct spray onto one or more module support legs. In one non-limiting example, one or more coatings are applied to the one or more module support legs (e.g., one or more metal legs) so as to inhibit or prevent oxidation of the one or more support legs. In the example shown in FIG. 4G, system 300 further includes a plurality of legs 331 coupling photovoltaic modules 330 of the array to mounting surface 313, and at least one spray nozzle 442 is configured so as to spray the product on the legs. Any suitable number of spray nozzles 442 can be coupled to any suitable number of reservoirs 441 and configured so as to spray the product on legs 331, e.g., two or more spray nozzles, each of which can be coupled to a common reservoir 441 or can be coupled to its own reservoir. The product can, for example, include an oxidation inhibitor. An exemplary oxidation inhibitor that can be applied to legs in the present systems is RUST-OLEUM 7785-830 Cold Galvanizing Compound Spray (commercially available from Rust-Oleum Corporation, Vernon Hills, Ill.).

In some embodiments, the SPOT maintenance vehicle includes a storage tank (reservoir) for one or more materials (products) to be fed to one or more nozzles. In certain embodiments, the storage tank is positioned on top of the SPOT maintenance vehicle. In some embodiments, the storage tank is positioned in any suitable location of the SPOT maintenance vehicle. For example, FIG. 4H illustrates an exemplary configuration in which reservoir 441 is located on top of maintenance vehicle 420. FIGS. 4A-4G illustrate exemplary configurations in which reservoir 441 is located at various locations of maintenance vehicle 420.

Note that spray nozzles 442 such as described with reference to FIGS. 4A-4H can be configured so as to spray product continuously as the maintenance module is moved laterally and sequentially in a direction parallel to the elongated rail, or can be configured so as to spray product intermittently or discontinuously as the maintenance module is moved laterally and sequentially in a direction parallel to the elongated rail. For example, spray nozzles 442 can be configured so as to spray product substantially only on module junction boxes 389, or substantially only on legs 331, or substantially only on modules 330. Additionally, system 300 can include any suitable number of spray heads, reservoirs, and/or maintenance vehicles so as to spray products on any suitable number of components of the system. For example, a single vehicle can be included that includes a plurality of reservoirs corresponding to different products, and that includes either a single adjustable spray head that is coupled to the different reservoirs and configured so as to selectively spray different products on different components of the system, or that includes multiple spray heads that each is configured so as to spray a respective product on a respective component of the system. Alternatively, a plurality of vehicles can be provided, each corresponding to a product to be sprayed on a respective component of the system.

Additionally, or alternatively, the maintenance module can include a remote inspection module. For example, in some embodiments, one or more cameras are mounted on the SPOT maintenance vehicle. For example, the one or more cameras are configured so as to record and send real-time video data to one or more power plant operators, allowing the one or more operators to visually inspect the power plant remotely. In some embodiments, one or more sensors (e.g., one or more sensors other than standard cameras) are mounted on the SPOT maintenance vehicle. For example, one or more infrared sensors are mounted on the SPOT maintenance vehicle and configured so as to reveal one or more hot spots in the power plant (e.g., one or more hot spots caused by solar module or electrical wire degradation).

For example, FIG. 5 is a simplified diagram showing a perspective view of a vehicle for remote inspection of at least one rail based array of photovoltaic modules, according to certain embodiments. In the example shown in FIG. 5, maintenance vehicle 520 can be configured similarly as vehicle 320 described herein with reference to FIGS. 3A-3D, and can include a maintenance module including one or more cameras 540, 541 configured so as to record and send real-time video data to one or more power plant operators, e.g., via a suitable wireless connection such as described elsewhere herein or otherwise known in the art. The camera(s), e.g., cameras 540, 541 can include any suitable combination of optics and an image sensor, such as a charge-coupled device (CCD), complementary metal-oxide-semiconductor (CMOS) sensor, n-type metal-oxide-semiconductor (NMOS) sensor, and/or infrared sensor configured so as to obtain digital images in any desired portion(s) of the optical spectrum, including the visible spectrum (e.g., wavelengths in the range of about 390-700 nm or any suitable portion thereof) and/or the infrared spectrum (e.g., wavelengths in the range of about 700 nm to 1 mm or any suitable portion thereof). The camera(s), e.g., cameras 540, 541 can be wirelessly coupled to a remote computer (not specifically illustrated) so as to transmit the images to such computer for real-time viewing or storage, or can be configured so as to upload the images to the internet for viewing in real-time or at a later time. The images can include still frames/snapshots, or can include a movie. In one nonlimiting example, each of the camera(s), e.g., cameras 540, 541 records a single image for each photovoltaic module past which it is moved. Optionally, data can be cached in a computer-readable storage medium of vehicle 520 and then transferred to a different computer-readable storage medium, such as a cloud storage service or a computer/database, while vehicle 520 is at its home base, while it is in active operation in the power plant, or as bandwidth becomes available.

FIGS. 6A-6E illustrate exemplary images that can be obtained using a vehicle for remote inspection of at least one rail based array of photovoltaic modules, according to certain embodiments. For example, FIG. 6A illustrates an exemplary image of photovoltaic surface 334 of photovoltaic module 330, which image was obtained using a visible-spectrum camera positioned similarly as camera 540 illustrated in FIG. 5, and FIG. 6B illustrates an exemplary image of wires 388 and junction box 389 under photovoltaic module(s) 330, which image was obtained using a visible-spectrum camera positioned similarly as camera 541 illustrated in FIG. 5. FIG. 6C illustrates an exemplary image of photovoltaic surface 334 of photovoltaic module 330, which image was obtained using a visible-spectrum camera positioned similarly as camera 540 illustrated in FIG. 5 and modified so as to simulate or suggest an exemplary appearance of an infrared image that can be obtained in configurations in which camera 540 includes an infrared sensor, and FIG. 6D illustrates an exemplary image of wires 388 and junction box 389 under photovoltaic module(s) 330, which image was obtained using a visible-spectrum camera positioned similarly as camera 541 illustrated in FIG. 5 and modified so as to simulate or suggest an exemplary appearance of an infrared image that can be obtained in configurations in which camera 541 includes an infrared sensor. FIG. 6E illustrates an exemplary image of photovoltaic surface 334 of photovoltaic module 330, which image was obtained using an infrared camera/sensor. Regions 335 of photovoltaic surface 334 were heated so as to simulate a hotspot or damaged section of module 330, which heated regions can be seen in FIG. 6E.

In addition to, or as an alternative to, one or both of a spray system and/or a remote inspection module, the present maintenance modules can include one or more vegetation management tools, such as a cutting head, that can be mounted onto the SPOT maintenance vehicle. For example, FIG. 7 is a simplified diagram showing a perspective view of a vehicle for trimming vegetation relative to at least one rail based array of photovoltaic modules, according to certain embodiments. Exemplary vehicle 720 illustrated in FIG. 7 includes cutting head 740 that can be configured so as to cut or trim vegetation relative to photovoltaic modules 330. For example, referring again to FIG. 3A, vegetation potentially can grow at installation surface 340, e.g., ground, next to or between elongated rails 310. Cutting head 740 of vehicle 720 illustrated in FIG. 7 can include one or more blades, e.g., a hedge trimmer, configured so as to trim vegetation to a height corresponding to a height of cutting head 740. In one example, the length of cutting head 740 is selected so as to be sufficiently shorter than the distance between elongated rails 310, so that cutting head 740 does not contact legs 331 of photovoltaic modules 330 or other components of system 300, but substantially only contacts and trims vegetation.

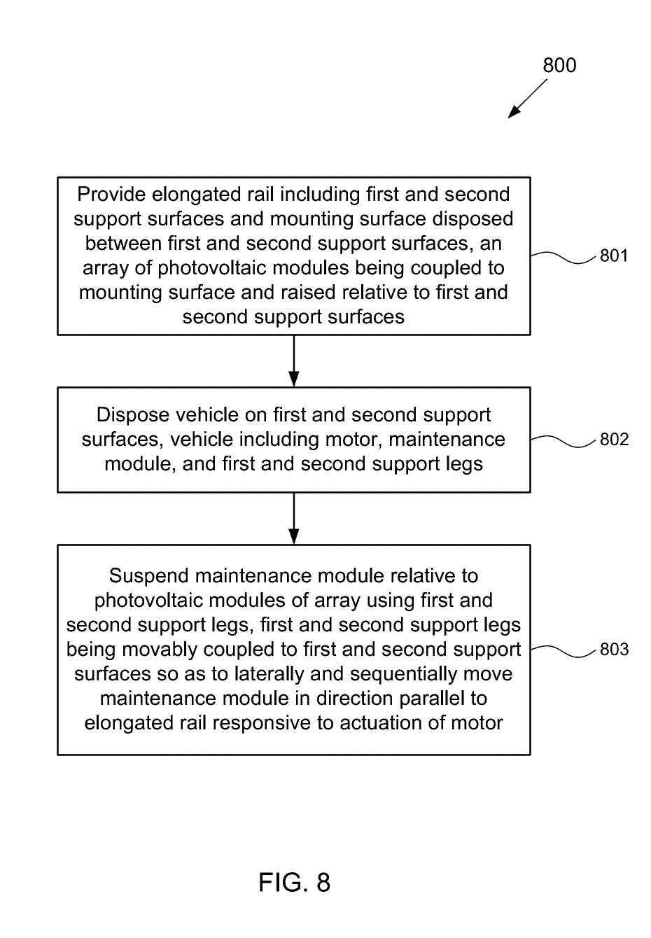

It should be appreciated that exemplary vehicles 320, 420, 520, and 720 described herein with reference to FIGS. 3A-3D, 4A-4H, 5, 6A-6E, and 7, or any suitable modification thereof, can be used in any suitable method for maintaining a rail based array of photovoltaic modules. For example, FIG. 8 illustrates steps in an exemplary method for maintaining at least one rail based array of photovoltaic modules, according to certain embodiments. Method 800 illustrated in FIG. 8 includes providing an elongated rail including first and second support surfaces and a mounting surface disposed between the first and second support surfaces, a first array of the photovoltaic modules being coupled to the mounting surface and raised relative to the first and second support surfaces (801). For example, the elongated rail and the photovoltaic modules can be configured similarly as described herein with reference to FIGS. 3A-3D.

Method 800 illustrated in FIG. 8 further can include disposing a vehicle on the first and second support surfaces, the vehicle including a motor; a maintenance module selected from the group consisting of: a spray system configured to spray a product, and a remote inspection module; and first and second support legs (802). Method 800 further can include suspending the maintenance module relative to the photovoltaic modules of the first array using the first and second support legs, the first and second support legs being movably coupled to the first and second support surfaces so as to laterally and sequentially move the maintenance module in a direction parallel to the first elongated rail responsive to actuation of the motor (803). For example, the vehicle can be configured similarly as described herein with reference to FIGS. 3A-3D, 4A-4G, 5, or 6A-6E.

In one nonlimiting example, the spray system includes a reservoir storing the product and a spray nozzle coupled to the reservoir and configured to spray the product. Illustratively, the product includes one or more of a protective material, an herbicide, a reflective coating, a dust suppressor, an insecticide, an animal deterrent, or a seed, e.g., such as described herein with reference to FIGS. 4A-4G. The product can include a liquid or a powder. The spray nozzle can be configured so as to spray the product relative to any suitable component. In one example, the first elongated rail is disposed on an installation surface, and method 800 can include the spray nozzle spraying the product on the installation surface, e.g., such as described herein with reference to FIGS. 4E-4F. Optionally, the system further can include a second elongated rail supporting a second array of photovoltaic modules, and method 800 can include the spray nozzle spraying the product on a region of the installation surface between the first elongated rail and the second elongated rail e.g., such as described herein with reference to FIGS. 4E-4F. The product can include a reflective coating or any other suitable coating such as described herein, e.g., such as described herein with reference to FIGS. 4E-4F.

As another example, method 800 can include the spray nozzle spraying the product on one or more backsheets of the photovoltaic modules of the first array e.g., such as described herein with reference to FIG. 4A. Illustratively, the product can include a protective material configured so as to improve weatherability of the photovoltaic modules of the first array. As another example, method 800 can include the spray nozzle spraying the product on the first elongated rail, e.g., such as described herein with reference to FIG. 4B. Illustratively, the product can include a protective material configured so as to improve weatherability or sealant to repair one or more cracks in the first elongated rail. As still another example, the system can include array wiring or a module junction box coupling the photovoltaic modules of the first array to one another, and method 800 can include the spray nozzle spraying the product on the array wiring or the module junction box, e.g., such as described herein with reference to FIG. 4C. Illustratively, the product can include an insulating layer. In yet another example, the system can include a plurality of legs coupling the photovoltaic modules of the first array to the first mounting surface, and method 800 can include the spray nozzle spraying the product on the legs, e.g., in a manner such as described herein with reference to FIG. 4G. Illustratively, the product can include an oxidation inhibitor. In another example, method 800 can include the spray nozzle spraying the product on photovoltaic surfaces of the first array of photovoltaic modules, e.g., such as described herein with reference to FIG. 4D. Illustratively, the product can include an anti-reflective coating.

Additionally, or alternatively, the remote inspection module can include a camera configured so as to record images of the first array of photovoltaic modules. Method 800 can include the camera recording images of photovoltaic surfaces of the first array of photovoltaic modules, e.g., in a manner such as described herein with reference to FIG. 5. In one example, the system can include array wiring or a module junction box coupling the photovoltaic modules of the first array to one another, and method 800 can include the camera recording images of the array wiring or module junction box. Additionally, or alternatively, the camera can include an infrared sensor, and the images can include infrared images.

Optionally, the vehicle further can include a cleaning tool, e.g., such as described herein with reference to FIGS. 9A-10C. Additionally, or alternatively, the vehicle can include a first set of one or more wheels or tread that travels along the first support surface, and a second set of one or more wheels or tread that travels along the second support surface, e.g., such as described herein with reference to FIGS. 3A-3D. Additionally, or alternatively, method 800 can include a row-to-row mechanism moving the first vehicle from the first elongated rail to a second elongated rail. Additionally, or alternatively, the first and second vehicle support surfaces and the at least one mounting surface can include extruded concrete disposed on the ground, e.g., such as described herein with reference to FIGS. 3A-3D.

It also should be appreciated that the present systems, vehicles, and methods can include any suitable combination of maintenance modules, e.g., any suitable combination of one or more of a spray system, remote inspection module, cutter, and cleaning head, provided on any suitable number of vehicles. For example, the present systems can include a plurality of vehicles each configured for two or more of remote inspection, cleaning, vegetation management, and/or spraying. In another example, the present systems can include a plurality of specialized vehicles, each being configured for a single one of remote inspection, cleaning, vegetation management, and/or spraying.

Further details of an optional, exemplary cleaning head, and operation thereof, as well as additional optional configurations of the present vehicles and systems, now will be provided with reference to FIGS. 9A-12.

As noted further above, at least a portion of optional cleaning head 340 can be vertically movable between a disengaged position spaced apart from photovoltaic modules 330 of the array and one or more engaged positions in contact with at least one of the photovoltaic modules 330 responsive to actuation of an actuator. In one illustrative embodiment, maintenance vehicle 320 includes a three-position optional cleaning head and actuator. Additionally, in one embodiment, the optional cleaning head can include a brush and a wiper or squeegee. In one embodiment, the three-position optional cleaning head has the following three positions:

Raised position: there is no contact with the panel;

Middle position: there is contact of the brush to the panel; and

Lowered position: there is contact of brush and squeegee with panel.

In another embodiment, the three-position optional cleaning head is actuated by cable. For example, a cable is used to connect the actuator to the optional cleaning head, allowing wheels to roll over the surface of the panel and control height.

For example, FIGS. 9A-9B are simplified diagrams showing perspective views of an optional cleaning head and actuator in a first position, according to certain embodiments. These diagrams are merely an example, which should not unduly limit the scope of the claims. One of ordinary skill in the art would recognize many variations, alternatives, and modifications. In one example, FIGS. 9A-9B illustrate a three-position optional cleaning head 340 in a raised position. Optional cleaning head 340 includes fluid reservoir 341, motor 342, first actuator 343, brush 344, shield 345, motor control cable 346, wiper or squeegee 347, and actuator control cable 349. Fluid reservoir 341 is configured so as to dispense fluid, such as water or other cleaning liquid, onto photovoltaic module 330 or onto brush 344 via a fluid tube, optionally responsive to actuation of a second actuator (fluid tube and second actuator not shown in FIGS. 9A-9B). The fluid can be dispensed from fluid reservoir 341 under the force of gravity, e.g., responsive to the second actuator opening a valve permitting the fluid to drip onto brush 344 or photovoltaic module 330 via the fluid tube. Alternatively, the second actuator can pump the fluid from fluid reservoir 341 onto brush 344 or photovoltaic module 330 via the fluid tube, e.g., can spray or jet the fluid onto brush 344 or photovoltaic module 330.

Motor 342 is configured so as to rotate brush 344 along an axis parallel to photovoltaic module 330. Motor 342 can include, for example, an electric motor or a combustion motor. In one illustrative embodiment, motor 342 shares a common power source with motor 327 described above with reference to FIGS. 3A-3D, such as solar panel 328 or a battery. Motor 342 can be connected to a controller such as described elsewhere herein via motor control cable 346.

First actuator 343 is configured so as to vertically move at least a portion of optional cleaning head 340, e.g., at least brush 344 and wiper or squeegee 347, between a raised or disengaged position such as illustrated in FIGS. 9A-9B and one or more engaged positions such as described further below with reference to FIGS. 10A-10C. First actuator 343 can include, for example, a hydraulic actuator, a pneumatic actuator, an electric actuator, or mechanical actuator. In one illustrative embodiment, first actuator shares a common power source with motor 327 described above with reference to FIGS. 3A-3D, such as solar panel 328 or a battery. First actuator 343 can be connected to a controller such as described elsewhere herein via actuator control cable 349.

Brush 344 can include a plurality of bristles that extend substantially radially from a central rod coupled to motor 342 (rod not shown in FIGS. 9A-9B). The plurality of bristles can include a material of sufficient strength and stiffness such that rotation of the bristles against photovoltaic module 330, optionally in the presence of fluid disposed from fluid reservoir 341, can remove debris, dust, or dirt from photovoltaic module 330, with sufficient softness and flexibility as to do so substantially without damaging the photovoltaic module. Exemplary materials that can be suitable for use in the bristles of brush 344 include nylon and polypropylene. Shield 345 can include a flat or shaped metal or plastic sheet that partially surrounds brush 344 so as to inhibit the rotation of brush 344 from flicking debris, dust, or dirt onto a different portion of photovoltaic module 330 or an adjacent photovoltaic module when brush 344 is rotating and in contact with photovoltaic module 330, e.g., as described in greater detail herein with reference to FIGS. 10A-10C.

Wiper or squeegee 347 can include a flexible hydrophilic material, such as natural rubber, silicone rubber, polyurethane, or other polymer such as ethylene propylene diene monomer (EPDM). Wiper or squeegee 347 can be configured so as to be oriented substantially parallel to and out of contact with photovoltaic module 330 in the raised position such as illustrated in FIGS. 9A-9B. For example, wiper or squeegee 347 can include pivot stop/panel rotation stop 348. FIGS. 9A-9B illustrate an exemplary position that includes, e.g., optional cleaning head in raised position, where neither brush not squeegee contacts glass surface of solar panel. For example, the squeegee position is aligned to brush head by one or more pivot stop, such as one or more panel rotation stops.

FIG. 10A-10C are simplified diagrams showing perspective views of an optional cleaning head and actuator in a second position, according to certain embodiments. These diagrams are merely an example, which should not unduly limit the scope of the claims. One of ordinary skill in the art would recognize many variations, alternatives, and modifications. FIGS. 10A-10C illustrate, e.g., optional cleaning head in lowered position and actuator, e.g., optional cleaning head in lowered position where brush and squeegee both contact glass surface of solar panel. For example, responsive to actuation of actuator 343 via actuation control cable 349, either brush 344 or both brush 344 and wiper or squeegee 347 can be lowered into contact with photovoltaic module 330. For example, at least a portion of optional cleaning head 320 (e.g., brush 344 and wiper or squeegee 347) can be vertically movable, responsive to actuation of actuator 343, to a first engaged position (e.g., lowered position) in which both the brush and the wiper or squeegee contact photovoltaic module 330 of the array. Additionally, or alternatively, at least a portion of optional cleaning head 320 (e.g., brush 344 and wiper or squeegee 347) can be vertically movable, responsive to actuation of actuator 343, to a second engaged position (e.g., middle position) in which the brush contacts photovoltaic module 330 of the array and the wiper does not contact the array. The first and second engaged positions can be discrete positions. Depending on which portion(s) of optional cleaning head 320 are moved so as to contact photovoltaic module 330, e.g., either brush 344 or both brush 344 and wiper or squeegee 347, such portion(s) can be moved laterally and sequentially in a direction parallel to elongated rail 310 and across each of the photovoltaic modules 330 of the array responsive to actuation of motor 327 such as discussed above with reference to FIGS. 3A-3D.

Additionally, responsive to actuation of motor 342 via motor control cable 346, brush 344 can be rotated so as to clean the surface of photovoltaic module 330. For example, the bristles of brush 344 can sweep debris, dirt, or dust off of the surface of photovoltaic module 330. Additionally, fluid from fluid reservoir 341 can be dispensed onto brush 344 or onto photovoltaic module 330, which can facilitate cleaning photovoltaic module 330. For example, as illustrated in FIGS. 3A-3D, photovoltaic module 330 can be disposed at a panel angle. Fluid dispensed from fluid reservoir 341 can collect the debris, dirt, or dust swept off of the surface of photovoltaic module 330, and the fluid then can flow to the bottom of module 330 under the force of gravity due to the panel angle of module 330. Additionally, or alternatively, in embodiments in which both brush 344 and wiper or squeegee 347 are in a position in which they are brought into contact with a photovoltaic module 330 and then moved laterally and sequentially in a direction parallel to elongated rail 310 and across photovoltaic modules 330 of the array, wiper or squeegee 347 can at least partially dry those modules. Additionally, or alternatively, in the lowered position, the one or more panel rotation stops are free of the squeegee, allowing the squeegee to follow glass surface of the solar panel. For example, as shown in FIG. 10C, panel rotation stop 348 can allow wiper or squeegee 347 to obtain one or more angles so as to follow a corresponding angled surface of photovoltaic module 330. According to certain embodiments, in the raised position and the middle position, the one or more panel rotation stops are engaged when the squeegee is lifted, aligning the squeegee to be parallel with surface of the panel.

Note that each of the various actuators and motors that can be included in maintenance vehicle 320 optionally can be powered by a common power source as one another, e.g., each can be powered by a common solar panel 328 or a common battery of vehicle 320. Alternatively, some of the actuators and motors can share a first common power source with one another, and others of the actuators and motors can share a second common power source with one another. Alternatively, each actuator and each motor can include its own power source.

Additionally, note that each of the various actuators and motors that can be included in maintenance vehicle 320 optionally can be controlled by a common controller as one another, e.g., each can be suitably connected to (such as by respective cabling) and controlled by a common controller of vehicle 320 that can be in wired or wireless communication with a remote computer that includes an interface by which a user may enter instructions, e.g., a web interface, that can be transmitted via an appropriate signal to the controller for implementation. The controller can include a memory and a processor coupled to the memory. The memory can store instructions for causing the processor to receive the instructions from the remote computer and then suitably to implement the instructions.

Illustratively, such instructions can include some or all of: a speed of motor 327, which can control the rate at which the maintenance module and/or optional cleaning head 340 moves relative to the photovoltaic modules 330 of the array and the start and stop times of motor 327 or rules defining when motor 327 should automatically start and stop; a speed or timing with which spray nozzles 442 spray product; a frequency with cameras 540, 541 obtain images; a speed of motor 342, which can control the rate at which brush 344 rotates and the start and stop times of motor 342 or rules defining when motor 342 should automatically start and stop; a speed of actuator 343, which can control the rate at which brush 344 and wiper or squeegee 347 can be moved vertically relative to the photovoltaic modules 330 and the start and stop times of actuator 343 or rules defining when actuator 343 should automatically start and stop; or a speed of the second actuator that controls dispensing of fluid from the fluid reservoir onto brush 344 or at least one of photovoltaic modules 330 of the array and the start and stop times of the second actuator or rules defining when the second actuator should automatically start and stop. Additionally, or alternatively, maintenance vehicle 320 can include a limit switch configured to detect one or both ends of elongated rail 310. The limit switch can be in operable communication with the controller. Illustratively, the limit switch can be mechanical, can be based on radio-frequency identification (RFID), or can be inductive/magnetic, although other suitable configurations can be used.

In one illustrative, nonlimiting example, the controller suitably is programmed (e.g., remotely, such as by web interface) so as to detect a first end of elongated rail 310 based on a signal from a limit switch, and responsive to such detection, to actuate the maintenance module and/or to actuate actuator 343 so as to lower brush 344 and optionally also wiper or squeegee 347 from a disengaged position into an engaged position. The controller also can be programmed so as to detect that the maintenance module was properly actuated and/or that actuator 343 properly positioned brush 344 and optionally also wiper or squeegee 347, and responsive to such detection, to actuate motor 342 so as to rotate brush 344 and to actuate the second actuator (not illustrated) so as to dispense fluid from fluid reservoir 341 onto brush 344 or photovoltaic module 330. The controller also can be programmed so as to detect that brush 344 properly is rotating and that fluid properly is being or has been dispensed, and responsive to such detection, to actuate motor 327 so as to laterally move maintenance vehicle 320, and thus to move brush 344 and optionally also wiper or squeegee 347, across the photovoltaic modules 330 of the array. The controller also can be programmed so as to detect a second end of elongated rail 310 based on a signal from the limit switch, and responsive to such detection, to disengage the maintenance module and/or to actuate actuator 343 so as to raise brush 344 and optionally also wiper or squeegee 347 from the engaged position into a disengaged position, to terminate actuation of motor 342 so as to stop rotation of brush 344, and to terminate actuation of motor 327 so as to stop lateral movement of vehicle 320.

Additionally, as noted further above with reference to FIGS. 3A-3D, system 300 can include a plurality of elongated rails 310, each of which can include one or more support surfaces and one or more mounting surfaces to which a respective array of photovoltaic modules 330 can be coupled. For example, a first elongated rail can include first and second support surfaces and a first mounting surface to which is coupled a first array of photovoltaic modules that are raised relative to the first and second support surfaces, and a second elongated rail can include third and fourth support surfaces and a second mounting surface to which is coupled a second array of photovoltaic modules that are raised relative to the third and fourth support surfaces. Different maintenance vehicles can be provided and used so as to maintain the first and second arrays of photovoltaic modules. For example, a first maintenance vehicle such as described herein can be disposed on the first and second support surfaces of the first elongated rail so as to maintain the first array of photovoltaic modules, and a second maintenance vehicle also such as described herein can be disposed on the third and fourth support surfaces of the second elongated rail so as to maintain the second array of photovoltaic modules.

Alternatively, one maintenance vehicle can be moved between rows by mechanism. For example, the system can include a row-to-row mechanism configured to move a maintenance vehicle from the first elongated rail to the second elongated rail. Illustratively, such a row-to-row mechanism can include at least one track that couples the first support surface of the first elongated rail to one of the third and fourth support surfaces of the second elongated rail, and that couples the second support surface of the first elongated rail to the other of the third and fourth support surfaces of the second elongated rail. In one embodiment, the row-to-row mechanism moves one maintenance vehicle to service two or more rows of solar panels. For example, the row-to-row mechanism is actuated by the maintenance vehicle. In another example, the row-to-row mechanism is actuated by a dedicated drive located on the ground with an independent power supply. In another embodiment, one or more solar panels are used to charge the row-to-row mechanism. In yet another embodiment, the row-to-row mechanism is dispatched based on presence of one or more maintenance vehicles. In yet another embodiment, the row-to-row mechanism is dispatched based on centralized wireless control.

In one illustrative, nonlimiting example, FIG. 11A is a simplified diagram showing a perspective view of an exemplary rail-to-rail mechanism for moving a maintenance vehicle from a first rail based array of photovoltaic modules to a second rail based array of photovoltaic modules, according to certain embodiments, e.g., row-to-row mechanism for moving the maintenance vehicle from one row to the next row of solar panels. This diagram is merely an example, which should not unduly limit the scope of the claims. One of ordinary skill in the art would recognize many variations, alternatives, and modifications. Rail-to-rail mechanism 600 illustrated in FIG. 11A includes first track 601, second track 602, and optional platform 605. Upon reaching the end of first elongated rail 310 including first support surface 313 and second support surface 314 to which maintenance vehicle 320 is movably coupled, the maintenance vehicle can move off of the end of first elongated rail 310 and either directly onto first and second tracks 601, 602 or onto optional platform 605 that can be supported by first and second tracks 601, 602. Maintenance vehicle 320 can travel along first and second tracks 601, 602, or can be moved by optional platform 605 along first and second tracks 601, 602, towards and into alignment with the end of second elongated rail 310′ including third support surface 313′ and fourth support surface 314′. Maintenance vehicle 320 can travel off of first and second tracks 601, 602 or off of optional platform 605 onto the third support surface 313′ and fourth support surface 314′ of second elongated rail 310′ so as to maintain photovoltaic modules 330 of second elongated rail 310′. In the embodiment illustrated in FIG. 11A, first track 601 can be considered to couple first support surface 313 to third support surface 313′, and second track 602 can be considered to couple second support surface 314 to fourth support surface 314′. Other configurations are possible.

For example, FIG. 11B is a simplified diagram showing a perspective view of another exemplary rail-to-rail mechanism for moving a maintenance vehicle from a first rail based array of photovoltaic modules to a second rail based array of photovoltaic modules, according to certain embodiments, e.g., a row-to-row track for moving the maintenance vehicle from one row to the next row of solar panels. This diagram is merely an example, which should not unduly limit the scope of the claims. One of ordinary skill in the art would recognize many variations, alternatives, and modifications. For example, the row-to-row track allows connection between two rows to maintain correct south-facing orientation. Rail-to-rail mechanism 600′ illustrated in FIG. 11B includes first track 601′, second track 602′, and optional platform 605′. Upon reaching the end of first elongated rail 310 including first support surface 313 and second support surface 314 to which maintenance vehicle 320 is movably coupled, the maintenance vehicle can move off of the end of first elongated rail 310 and either directly onto first and second tracks 601′, 602′ or onto optional platform 605′ that can be supported by first and second tracks 601′, 602′. Maintenance vehicle 320 can travel along first and second tracks 601′, 602′, or can be moved by optional platform 605′ along first and second tracks 601′, 602′, towards and into alignment with the end of second elongated rail 310′ including third support surface 313′ and fourth support surface 314′. Maintenance vehicle 320 can travel off of first and second tracks 601′, 602′ or off of optional platform 605′ onto the third support surface 313′ and fourth support surface 314′ of second elongated rail 310′ so as to maintain photovoltaic modules 330 of second elongated rail 310′. In the embodiment illustrated in FIG. 11B, first track 601′ can be considered to couple first support surface 313 to fourth support surface 314′, and second track 602′ can be considered to couple second support surface 314 to third support surface 313′. Other configurations are possible.

For example, FIG. 11C is a simplified diagram showing a perspective view of yet another exemplary rail-to-rail mechanism for moving a maintenance vehicle from a first rail based array of photovoltaic modules to a second rail based array of photovoltaic modules, according to certain embodiments, e.g., row-to-row track for moving the maintenance vehicle from on row to the next row of solar panels. This diagram is merely an example, which should not unduly limit the scope of the claims. One of ordinary skill in the art would recognize many variations, alternatives, and modifications. Rail-to-rail mechanism 600″ illustrated in FIG. 11C includes first track 601″, second track 602″, third track 603″, fourth track 604″, and optional platform 605″. Upon reaching the end of first elongated rail 310 including first support surface 313 and second support surface 314 to which maintenance vehicle 320 is movably coupled, the maintenance vehicle can move off of the end of first elongated rail 310 and either directly onto first and second tracks 601″, 602″ or onto optional platform 605″ that can be supported by first and second tracks 601″, 602″. Maintenance vehicle 320 can travel along first and second tracks 601″, 602″, or can be moved by optional platform 605″ along first and second tracks 601″, 602″ towards an intermediate position at which maintenance vehicle 320 then can travel along third and fourth tracks 603″, 604″ or can be moved by optional platform 605″ along third and fourth tracks 603″, 604″ towards and into alignment with the end of second elongated rail 310′ including third support surface 313′ and fourth support surface 314′. Maintenance vehicle 320 can travel off of third and fourth tracks 603″, 604″ or off of optional platform 605″ onto the third support surface 313′ and fourth support surface 314′ of second elongated rail 310′ so as to maintain photovoltaic modules 330 of second elongated rail 310′. In the embodiment illustrated in FIG. 11C, first and second tracks 601″, 602″ can be considered to couple first support surface 313 to third support surface 313′, and third and fourth tracks 603″, 604″ can be considered to couple second support surface 314 to fourth support surface 314′. Other configurations are possible.

Note that in embodiments in which the row-to-row mechanism includes a platform coupled to the at least one track and configured to carry the maintenance vehicle from the first elongated rail 310 to the second elongated rail 310′, e.g., platform 605 coupled to tracks 601 and 602, or platform 605′ coupled to tracks 601′ and 602′, or platform 605″ coupled to tracks 601″, 602″, 603″, and 604″, the row-to-row mechanism optionally can include a power source and a motor coupled to the platform and configured to move the platform based on power from the power source. Exemplary power sources include DC electrical power such as from a photovoltaic module or solar panel, or batter, and AC electrical power, such as from an electrical grid.

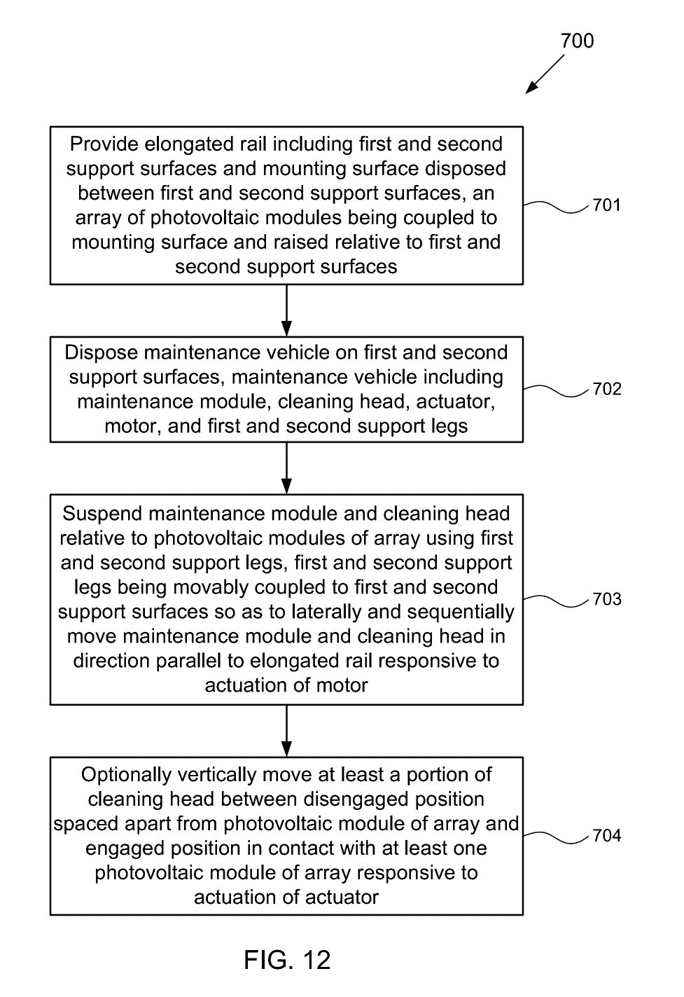

FIG. 12 illustrates steps in an exemplary method for maintaining at least one rail based array of photovoltaic modules, according to certain embodiments. This diagram is merely an example, which should not unduly limit the scope of the claims. One of ordinary skill in the art would recognize many variations, alternatives, and modifications. Method 700 illustrated in FIG. 12 includes providing an elongated rail including first and second support surfaces and a mounting surface disposed between the first and second support surfaces, an array of photovoltaic modules being coupled to the mounting surface and raised relative to the first and second support surfaces (701). In one illustrative, nonlimiting example, elongated rail 310 described above with reference to FIGS. 3A-3D can be provided including first and second support surfaces 313, 314 and one or more mounting surfaces 311 disposed therebetween. A plurality of photovoltaic modules 330 can be coupled to the mounting surface(s), e.g., via legs 331 that can raise photovoltaic modules 330 above first and second support surfaces 313, 314.

Referring again to FIG. 12, method 700 further can include disposing a maintenance vehicle on the first and second support surfaces, the maintenance vehicle including a maintenance module, a cleaning head, actuator, motor, and first and second support legs (702). In one illustrative, nonlimiting example, maintenance vehicle 320 described above with reference to FIGS. 3A-10C can be disposed on first and second support surfaces 313, 314 of elongated rail 310, e.g., via wheels or caterpillar treads coupled to first and second support legs 322, 323, and any other (optional) legs that vehicle 320 can include. In this example, maintenance vehicle 320 includes both a maintenance module, e.g., spray system, remote inspection module, or cutting head, and an optional cleaning head 340 including actuator 343 and motor 327.

As illustrated in FIG. 12, method 700 also can include suspending the maintenance module and cleaning head relative the photovoltaic modules of the array using the first and second support legs, the first and second support legs being movably coupled to the first and second support surfaces so as to laterally and sequentially move the cleaning head in a direction parallel to the elongated rail responsive to actuation of the motor (703). In one illustrative, nonlimiting example, maintenance vehicle 320 illustrated in FIGS. 3A-3D can suspend the maintenance module and optional cleaning head 340 relative to photovoltaic modules 330 of the array using first and second support legs 321, 322 and any other (optional) legs that vehicle 320 can include. The first and second support legs 321, 322 can be movably coupled, e.g., via wheels or caterpillar treads, to first and second support surfaces 313, 314. Actuation of motor 327 can cause maintenance vehicle 320 to laterally move along elongated rail 310 in a direction parallel to elongated rail 310, so as to laterally and sequentially move the maintenance module and cleaning head 340 in a direction parallel to elongated rail 310 and relative to, e.g., across, photovoltaic modules 330 of the array.

Referring again to FIG. 12, method 700 optionally also can include vertically moving at least a portion of the optional cleaning head between a disengaged position spaced apart from the photovoltaic module of the array and an engaged position in contact with at least one photovoltaic module of the array responsive to actuation of the actuator (704). In one nonlimiting, illustrative example, as discussed above with reference to FIGS. 9A-10C, actuator 343 can cause brush 344 and wiper or squeegee 347 to be raised or lowered relative to photovoltaic module 330, e.g., such that brush 344 or both brush 344 and wiper or squeegee 347 can contact photovoltaic module 330. In an alternative embodiment, an actuator can cause additional portions, or even the entirety, of optional cleaning head 340 to be raised or lowered so as to contact photovoltaic module 330. In still other embodiments, cleaning head can have a substantially fixed position within vehicle 320. As discussed with reference to FIGS. 9A-10C, additional motors or actuators can cause additional actions that can facilitate cleaning photovoltaic module 330. For example, actuation of a second motor 342 can cause rotation of brush 344 about an axis parallel to photovoltaic module 330, or actuation of a second actuator (not illustrated) can cause fluid to be dispensed from fluid reservoir 341 onto brush 344 or onto photovoltaic module 330.

Note that the steps of method 700 can be performed in any suitable order. For example, disposing the maintenance vehicle on the first and second support surfaces (702) can occur concurrently with suspending the maintenance module and cleaning head relative to the photovoltaic modules of the array using the first and second support legs (703). That is, performing the disposing also may perform the suspending. Additionally, laterally and sequentially moving the maintenance module and cleaning head in a direction parallel to the elongated rail (703) can be performed before, during, or after optionally vertically moving at least a portion of the cleaning head between the disengaged and engaged positions (704). In one illustrative, nonlimiting example, as mentioned above with reference to FIGS. 9A-10C, a controller of maintenance vehicle 320 suitably can be programmed to actuate actuator 343 so as to lower at least a portion of cleaning head 340 into contact with photovoltaic module before actuating motor 327 so as to cause lateral movement of optional cleaning head 340.

According to yet another embodiment, a system for maintaining photovoltaic modules includes a first elongated rail including first and second support surfaces and a first mounting surface disposed between the first and second support surfaces, a first array of the photovoltaic modules being coupled to the first mounting surface and raised relative to the first and second support surfaces. The system also can include a first vehicle disposed on the first and second support surfaces. The first vehicle can include a motor; a maintenance module selected from the group consisting of: a spray system configured to spray a product, and a remote inspection module; and first and second support legs suspending the maintenance module relative to the photovoltaic modules of the first array and being movably coupled to the first and second support surfaces so as to laterally and sequentially move the maintenance module in a direction parallel to the first elongated rail responsive to actuation of the motor. Exemplary embodiments of such a system are described herein, for example, with reference to FIGS. 3A-3D, 4A-4H, and 5.

According to still another embodiment, a method for maintaining photovoltaic modules includes providing a first elongated rail including first and second support surfaces and a first mounting surface disposed between the first and second support surfaces, a first array of the photovoltaic modules being coupled to the first mounting surface and raised relative to the first and second support surfaces. The method also can include disposing a first vehicle on the first and second support surfaces. The first vehicle can include a motor; a maintenance module selected from the group consisting of: a spray system configured to spray a product, and a remote inspection module; and first and second support legs. The method also can include suspending the maintenance module relative to the photovoltaic modules of the first array using the first and second support legs, the first and second support legs being movably coupled to the first and second support surfaces so as to laterally and sequentially move the maintenance module in a direction parallel to the first elongated rail responsive to actuation of the motor. Exemplary embodiments of such a method are described herein, for example, with reference to FIG. 6.

Although specific embodiments of the present invention have been described, it will be understood by those of skill in the art that there are other embodiments that are equivalent to the described embodiments. For example, various embodiments and/or examples of the present invention can be combined. Accordingly, it is to be understood that the invention is not to be limited by the specific illustrated embodiments, but only by the scope of the appended claims.

1. A system for maintaining photovoltaic modules, the system including:
a first elongated rail including first and second support surfaces and a first mounting surface disposed between the first and second support surfaces, a first array of the photovoltaic modules being coupled to the first mounting surface and raised relative to the first and second support surfaces; and
a first vehicle disposed on the first and second support surfaces, the first vehicle including:
a motor;
a maintenance module selected from the group consisting of: a spray system configured to spray a product, and a remote inspection module; and
first and second support legs suspending the maintenance module relative to the photovoltaic modules of the first array and being movably coupled to the first and second support surfaces so as to laterally and sequentially move the maintenance module in a direction parallel to the first elongated rail responsive to actuation of the motor.

2. The system of claim 1, wherein the spray system comprises a reservoir storing the product and a spray nozzle coupled to the reservoir and configured to spray the product.

3. The system of claim 1, wherein the product comprises one or more of a protective material, an herbicide, a reflective coating, a dust suppressor, an insecticide, an animal deterrent, or a seed.

4. The system of claim 1, wherein the product comprises a liquid.

5. The system of claim 1, wherein the product comprises a powder.

6. The system of claim 1, wherein the first elongated rail is disposed on an installation surface, and wherein the spray nozzle is configured so as to spray the product on the installation surface.

7. The system of claim 6, further comprising a second elongated rail supporting a second array of photovoltaic modules, wherein the spray nozzle is configured so as to spray the product on a region of the installation surface between the first elongated rail and the second elongated rail.

8. The system of claim 6, wherein the product comprises a reflective coating.

9. The system of claim 6, wherein the product comprises an herbicide.

10. The system of claim 2, wherein the spray nozzle is configured so as to spray the product on one or more backsheets of the photovoltaic modules of the first array.

11. The system of claim 10, wherein the product comprises a protective material configured so as to improve weatherability of the photovoltaic modules of the first array.

12. The system of claim 2, wherein the spray nozzle is configured so as to spray the product on the first elongated rail.

13. The system of claim 12, wherein the product comprises a protective material configured so as to improve weatherability or sealant to repair one or more cracks in the first elongated rail.

14. The system of claim 2, further comprising array wiring or a module junction box coupling the photovoltaic modules of the first array to one another, wherein the spray nozzle is configured so as to spray the product on the array wiring or the module junction box.

15. The system of claim 14, wherein the product comprises an insulating layer.

16. The system of claim 2, further comprising a plurality of legs coupling the photovoltaic, modules of the first array to the first mounting surface, wherein the spray nozzle is configured so as to spray the product on the legs.

17. The system of claim 16, wherein the product comprises an oxidation inhibitor.

18. The system of claim 2, wherein the spray nozzle is configured so as to spray the product on photovoltaic surfaces of the first array of photovoltaic modules.

19. The system of claim 18, wherein the product comprises an anti-reflective coating.

20. The system of claim 1, wherein the remote inspection module comprises a camera configured so as to record images of the first array of photovoltaic modules.

21. The system of claim 20, wherein the camera is configured to record images of photovoltaic surfaces of the first array of photovoltaic modules.

22. The system of claim 20, further comprising array wiring or a module junction box coupling the photovoltaic modules of the first array to one another, wherein the camera is configured to record images of the array wiring or module junction box.

23. The system of claim 20, wherein the camera comprises an infrared sensor, and wherein the images comprise infrared images.

24. The system of claim 1, wherein the vehicle further comprises a cleaning tool.

25. The system of claim 1, wherein the vehicle comprises a first set of one or more wheels or tread that travels along the first support surface, and a second set of one or more wheels or tread that travels along the second support surface.

26. The system of claim 1, further including a row-to-row mechanism configured to move the first vehicle from the first elongated rail to a second elongated rail.

27. The system of claim 1, wherein the first and second vehicle support surfaces and the at least one mounting surface comprise extruded concrete disposed on the ground.

28. A method for maintaining photovoltaic modules, the method including:
providing a first elongated rail including first and second support surfaces and a first mounting surface disposed between the first and second support surfaces, a first array of the photovoltaic modules being coupled to the first mounting surface and raised relative to the first and second support surfaces; and
disposing a first vehicle on the first and second support surfaces, the first vehicle including:
a motor;
a maintenance module selected from the group consisting of: a spray system configured to spray a product, and a remote inspection module; and
first and second support legs; and
suspending the maintenance module relative to the photovoltaic modules of the first array using the first and second support legs, the first and second support legs being movably coupled to the first and second support surfaces so as to laterally and sequentially move the maintenance module in a direction parallel to the first elongated rail responsive to actuation of the motor.

29-54. (canceled)
